(19) United States
(12) Patent Application Publication
(10) Pub. No.: US 2024/0188085 A1
(43) Pub. Date: Jun. 6, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/520,576

(22) Filed: Nov. 28, 2023

(30) Foreign Application Priority Data
Nov. 29, 2022 (CN) 202211511835.4

(51) Int. Cl. H04W 72/21; H04L 1/1829; H04L 5/00

(52) U.S. Cl. CPC H04W 72/21; H04L 1/1854; H04L 5/0055

(57) ABSTRACT

A first receiver receives a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); a first transmitter transmits a first PUSCH, the first PUSCH carries a target coded bit group; herein, a first UCI coded bit sequence comprises coded bits for UCI, and a length of the first UCI coded bit sequence depends on the second parameter, the target coded bit group depends on the first UCI coded bit sequence, and at least one of the target coded bit group or the first UCI coded bit sequence depends on a target HARQ-ACK bit block.

### CROSS REFERENCE TO RELATED APPLICATIONS

This application claims the priority benefit of Chinese Patent Application No. 202211511835.4, filed on Nov. 29, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

In the discussion on 5G New Radio (NR), 3GPP agreed to support transmitting two codewords on a Physical Uplink Shared Channel (PUSCH); after introducing the function of using one PUSCH to transmit two codewords, how to implement the multiplexing of Uplink Control Information (UCI) on the PUSCH is a key issue that must be addressed.

### SUMMARY

To address the above problem, the present application provides a solution. It should be noted that the present application can be applied to various wireless communication scenarios, such as Enhanced Mobile Broadband (eMBB). Ultra Reliable and Low Latency Communication (URLLC), Multicast Broadcast Services (MBS), Internet of Things (IoT), Internet of Vehicles, non-terrestrial networks (NTN), shared spectrum, and etc., where similar technical effects can be achieved. In addition, the adoption of a unified solution in different scenarios (including but not limited to eMBB, URLLC, MBS, IoT, Internet of Vehicles, NTN, shared spectrum) also helps to reduce hardware complexity and cost, or improve performance. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling, the first signaling being used to determine a first parameter and a second parameter, the first parameter and the second parameter being respectively for two Transport Blocks (TBs), the first parameter being one of MCS-related parameters or a number of transmission layer(s), and the second parameter being one of MCS-related parameters or a number of transmission layer(s); and
transmitting a first PUSCH, the first PUSCH carrying a target coded bit group, the target coded bit group comprising multiple coded bits:
herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one embodiment. advantages of the above method comprise; improving the performance of UCI feedback.

In one embodiment, advantages of the above method comprise; improving the performance of HARQ-ACK feedback.

In one embodiment, advantages of the above method comprise; optimizing resource allocation between a multiplexed UCI and an Uplink shared channel (UL-SCH) TB.

In one embodiment, advantages of the above method comprise; when the target condition is met, a determination of the first UCI coded bit sequence and a determination of the first reserved resource pool respectively depend on MCS parameters for different TBs, thus optimizing the allocation of PUSCH resources between different UCIs or between a UCI and a UL-SCH.

In one embodiment, advantages of the above method comprise; when the target condition is met, a determination of the first UCI coded bit sequence and a determination of the first reserved resource pool respectively depend on a number of transmission layer(s) for different TBs, thus optimizing the allocation of PUSCH resources between different UCIs or between a UCI and a UL-SCH.

In one embodiment, advantages of the above method comprise; improving the method of determining a set of reserved resource elements used for potential HARQ-ACK transmission, thus improving the transmission performance of a PUSCH that multiplexes a UCI.

In one embodiment, advantages of the above method comprise: avoiding reserving excessive resources for a HARQ-ACK transmission, thus improving the transmission performance of a CSI or a UL-SCH.

In one embodiment, advantages of the above method comprise: improving the resource utilization.

In one embodiment, advantages of the above method comprise: having good compatibility.

In one embodiment, advantages of the above method comprise: incurring minor changes to the existing 3GPP standard.

According to one aspect of the present application, the above method is characterized in that
when the target condition is not met, the first reserved resource pool is an empty set.

According to one aspect of the present application, the above method is characterized in that
the target coded bit group comprises coded bits for only one of the two TBs.

According to one aspect of the present application, the above method is characterized in that
all bits in the target coded bit group are bits in a same codeword.

According to one aspect of the present application, the above method is characterized in that
the target coded bit group comprises a first target coded bit sequence and a second target coded bit sequence. the first target coded bit sequence and the second target coded bit sequence respectively comprise coded bits for the two TBs, and the first UCI coded bit sequence is used to determine the first target coded bit sequence.

According to one aspect of the present application, the above method is characterized in that
the first parameter is a modulation order of one of the two TBs, and the second parameter is a modulation order of the other of two TBs.

According to one aspect of the present application, the above method is characterized in that
the first parameter is a target code rate of one of the two TBs, and the second parameter is a target code rate of the other of the two TBs.

According to one aspect of the present application, the above method is characterized in that
the first parameter is a number of transmission layer(s) of one of the two TBs, and the second parameter is a number of transmission layer(s) of the other of the two TBs.

According to one aspect of the present application, the above method is characterized in that
the length of the first UCI coded bit sequence is equal to a product of multiple values, the multiple values are non-negative integers, and one of the multiple values is the second parameter.

According to one aspect of the present application, the above method is characterized in that

when the target condition is satisfied: the first parameter is used to determine a first interval, the first interval is a positive integer, and the first reserved resource pool depends on the first interval.

According to one aspect of the present application, the above method is characterized in that
when the target condition is met, the first reserved resource pool is a set of reserved resource elements for potential HARQ-ACK transmission in at least one OFDM symbol; the target condition comprises: a number of HARQ-ACK bit(s) comprised in the target HARQ-ACK bit block is not greater than 2.

According to one aspect of the present application, the above method is characterized in that
the target coded bit group comprises a first target coded bit sequence and a second target coded bit sequence. the first target coded bit sequence and the second target coded bit sequence respectively comprise coded bits for the two TBs; when the target condition is met, the second target coded bit sequence depends on the first reserved resource pool.

According to one aspect of the present application, the above method is characterized in that
the target coded bit group comprises a first target coded bit sequence and a second target coded bit sequence. the first target coded bit sequence and the second target coded bit sequence respectively comprise coded bits for the two TBs; when the target condition is met, the first target coded bit sequence depends on the first reserved resource pool.

According to one aspect of the present application, the above method is characterized in that
the target coded bit group comprises a first target coded bit sequence and a second target coded bit sequence. the first target coded bit sequence and the second target coded bit sequence respectively comprise coded bits for the two TBs; when the target condition is met, the first target coded bit sequence depends on the first reserved resource pool, the second target coded bit sequence depends on the first reserved resource pool.

The present application provides a method in a second node for wireless communications, comprising:
transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
receiving a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

According to one aspect of the present application, the above method is characterized in that
when the target condition is not met, the first reserved resource pool is an empty set.

According to one aspect of the present application, the above method is characterized in that
the target coded bit group comprises coded bits for only one of the two TBs.

According to one aspect of the present application, the above method is characterized in that
all bits in the target coded bit group are bits in a same codeword.

According to one aspect of the present application, the above method is characterized in that
the target coded bit group comprises a first target coded bit sequence and a second target coded bit sequence,
the first target coded bit sequence and the second target coded bit sequence respectively comprise coded bits for the two TBs, and the first UCI coded bit sequence is used to determine the first target coded bit sequence.

According to one aspect of the present application, the above method is characterized in that
the first parameter is a modulation order of one of the two TBs, and the second parameter is a modulation order of the other of two TBs.

According to one aspect of the present application, the above method is characterized in that
the first parameter is a target code rate of one of the two TBs, and the second parameter is a target code rate of the other of the two TBs.

According to one aspect of the present application, the above method is characterized in that
the first parameter is a number of transmission layer(s) of one of the two TBs, and the second parameter is a number of transmission layer(s) of the other of the two TBs.

According to one aspect of the present application, the above method is characterized in that
the length of the first UCI coded bit sequence is equal to a product of multiple values, the multiple values are non-negative integers, and one of the multiple values is the second parameter.

According to one aspect of the present application, the above method is characterized in that
when the target condition is satisfied: the first parameter is used to determine a first interval, the first interval is a positive integer, and the first reserved resource pool depends on the first interval.

According to one aspect of the present application, the above method is characterized in that
when the target condition is met, the first reserved resource pool is a set of reserved resource elements for potential HARQ-ACK transmission in at least one OFDM symbol; the target condition comprises: a number of HARQ-ACK bit(s) comprised in the target HARQ-ACK bit block is not greater than 2.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs; when the target condition is met, the second target coded bit sequence depends on the first reserved resource pool.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool, the second target coded bit sequence depends on the first reserved resource pool.

The present application provides a first node for wireless communications, comprising:
a first receiver, receiving a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
a first transmitter, transmitting a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

The present application provides a second node for wireless communications, comprising:
a second transmitter, transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
a second receiver, receiving a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

The present application provides a method in a first node for wireless communications, comprising:
receiving a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
transmitting a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one embodiment, advantages of the above method comprise: improving the performance of UCI feedback.

In one embodiment, advantages of the above method comprise: improving the performance of HARQ-ACK

feedback.

In one embodiment, advantages of the above method comprise: optimizing resource allocation between a multiplexed UCI and a UL-SCH TB.

In one embodiment, advantages of the above method comprise: a determination of the first UCI coded bit sequence and a determination of the first reserved resource pool respectively depend on MCS parameters for different TBs, thus optimizing the allocation of PUSCH resources between different UCIs or between a UCI and a UL-SCH.

In one embodiment, advantages of the above method comprise: a determination of the first UCI coded bit sequence and a determination of the first reserved resource pool respectively depend on a number of transmission layer(s) for different TBs, thus optimizing the allocation of PUSCH resources between different UCIs or between a UCI and a UL-SCH.

In one embodiment, advantages of the above method comprise: improving the method of determining a set of reserved resource elements for potential HARQ-ACK transmission, and improving the transmission performance of a PUSCH that multiplexes a UCI.

In one embodiment, advantages of the above method comprise: avoiding reserving excessive resources for a HARQ-ACK transmission, thus improving the transmission performance of a CSI or a UL-SCH.

In one embodiment, advantages of the above method comprise: improving resource utilization.

In one embodiment, advantages of the above method comprise: having good compatibility.

In one embodiment, advantages of the above method comprise: incurring minor changes to the existing 3GPP standard.

According to one aspect of the present application, the above method is characterized in that
the target coded bit group comprises coded bits for only one of the two TBs.

According to one aspect of the present application, the above method is characterized in that
all bits in the target coded bit group are bits in a same codeword.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs, and the second target coded bit sequence depends on the first reserved resource pool.

According to one aspect of the present application, the above method is characterized in that
the target coded bit group comprises a first target coded bit sequence and a second target coded bit sequence. the first target coded bit sequence and the second target coded bit sequence respectively comprise coded bits for the two TBs, and the first target coded bit sequence depends on the first reserved resource pool.

According to one aspect of the present application, the above method is characterized in that
the target coded bit group comprises a first target coded bit sequence and a second target coded bit sequence. the first target coded bit sequence and the second target coded bit sequence respectively comprise coded bits for the two TBs, the first target coded bit sequence depends on the first reserved resource pool, and the second target coded bit sequence depends on the first reserved resource pool.

According to one aspect of the present application, the above method is characterized in that
the first parameter is a modulation order of one of the two TBs, and the second parameter is a modulation order of the other of two TBs.

According to one aspect of the present application, the above method is characterized in that
the first parameter is a target code rate of one of the two TBs, and the second parameter is a target code rate of the other of the two TBs.

According to one aspect of the present application, the above method is characterized in that
the first parameter is a number of transmission layer(s) of one of the two TBs, and the second parameter is a number of transmission layer(s) of the other of the two TBs.

According to one aspect of the present application, the above method is characterized in that
the length of the first UCI coded bit sequence is equal to a product of multiple values, the multiple values are non-negative integers, and one of the multiple values is the second parameter.

According to one aspect of the present application, the above method is characterized in that
the first parameter is used to determine a first interval, the first interval is a positive integer, and the first reserved resource pool depends on the first interval.

According to one aspect of the present application, the above method is characterized in that
the first reserved resource pool is a set of reserved resource elements for potential HARQ-ACK transmission in at least one OFDM symbol.

According to one aspect of the present application, the above method is characterized in that
the target coded bit group comprises the first UCI coded bit sequence.

The present application provides a method in a second node for wireless communications, comprising:
transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
receiving a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

According to one aspect of the present application, the above method is characterized in that
the target coded bit group comprises coded bits for only one of the two TBs.

According to one aspect of the present application, the above method is characterized in that
all bits in the target coded bit group are bits in a same codeword.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs, and the second target coded bit sequence depends on the first reserved resource pool.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs, and the first target coded bit sequence depends on the first reserved resource pool.

According to one aspect of the present application, the above method is characterized in that
the target coded bit group comprises a first target coded bit sequence and a second target coded bit sequence, the first target coded bit sequence and the second target coded bit sequence respectively comprise coded bits for the two TBs, the first target coded bit sequence depends on the first reserved resource pool, and the second target coded bit sequence depends on the first reserved resource pool.

According to one aspect of the present application, the above method is characterized in that
the first parameter is a modulation order of one of the two TBs, and the second parameter is a modulation order of the other of two TBs.

According to one aspect of the present application, the above method is characterized in that
the first parameter is a target code rate of one of the two TBs, and the second parameter is a target code rate of the other of the two TBs.

According to one aspect of the present application, the above method is characterized in that
the first parameter is a number of transmission layer(s) of one of the two TBs, and the second parameter is a number of transmission layer(s) of the other of the two TBs.

According to one aspect of the present application, the above method is characterized in that
the length of the first UCI coded bit sequence is equal to a product of multiple values, the multiple values are non-negative integers, and one of the multiple values is the second parameter.

According to one aspect of the present application, the above method is characterized in that
the first parameter is used to determine a first interval, the first interval is a positive integer, and the first reserved resource pool depends on the first interval.

According to one aspect of the present application, the above method is characterized in that
the first reserved resource pool is a set of reserved resource elements for potential HARQ-ACK transmission in at least one OFDM symbol.

According to one aspect of the present application, the above method is characterized in that
the target coded bit group comprises the first UCI coded bit sequence.

The present application provides a first node for wireless communications, comprising:
a first receiver, receiving a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
a first transmitter, transmitting a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

According to one aspect of the present application, the above node is characterized in that
the target coded bit group comprises coded bits for only one of the two TBs.

According to one aspect of the present application, the above node is characterized in that
all bits in the target coded bit group are bits in a same codeword.

According to one aspect of the present application, the above node is characterized in that
the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

According to one aspect of the present application, the above node is characterized in that
the target coded bit group comprises a first target coded bit sequence and a second target coded bit sequence, the first target coded bit sequence and the second target coded bit sequence respectively comprise coded bits for the two TBs, and the second target coded bit sequence depends on the first reserved resource pool.

According to one aspect of the present application, the above node is characterized in that
the target coded bit group comprises a first target coded bit sequence and a second target coded bit sequence, the first target coded bit sequence and the second target coded bit sequence respectively comprise coded bits for the two TBs, and the first target coded bit sequence depends on the first reserved resource pool.

According to one aspect of the present application, the above node is characterized in that
the target coded bit group comprises a first target coded bit sequence and a second target coded bit sequence, the first target coded bit sequence and the second target coded bit sequence respectively comprise coded bits for the two TBs, the first target coded bit sequence depends on the first reserved resource pool, and the second target coded bit sequence depends on the first reserved resource pool.

According to one aspect of the present application, the above node is characterized in that
the first parameter is a modulation order of one of the two TBs, and the second parameter is a modulation order of the other of two TBs.

According to one aspect of the present application, the above node is characterized in that
the first parameter is a target code rate of one of the two TBs, and the second parameter is a target code rate of the other of the two TBs.

According to one aspect of the present application, the above node is characterized in that
the first parameter is a number of transmission layer(s) of one of the two TBs, and the second parameter is a number of transmission layer(s) of the other of the two TBs.

According to one aspect of the present application, the above node is characterized in that
the length of the first UCI coded bit sequence is equal to a product of multiple values, the multiple values are non-negative integers, and one of the multiple values is the second parameter.

According to one aspect of the present application, the above node is characterized in that
the first parameter is used to determine a first interval, the first interval is a positive integer, and the first reserved resource pool depends on the first interval.

According to one aspect of the present application, the above node is characterized in that
the first reserved resource pool is a set of reserved resource elements for potential HARQ-ACK transmission in at least one OFDM symbol.

According to one aspect of the present application, the above node is characterized in that
the target coded bit group comprises the first UCI coded bit sequence.

The present application provides a second node for wireless communications, comprising:
a second transmitter, transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
a second receiver, receiving a first PUSCH, the first PUSCH carrying a target coded bit group, the target coded bit group comprising multiple coded bits;
herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of signal transmission according to one embodiment of the present application;

FIG. 6 illustrate a schematic diagram of relations among a first parameter, a first interval and a first reserved resource pool when a target condition is satisfied according to one embodiment of the present application;

FIG. 7 illustrates a schematic diagram of a target coded bit group according to one embodiment of the present application;

FIG. 8 illustrates a schematic diagram of relations among a target coded bit group, a first target coded bit sequence, a second target coded bit sequence, two TBs and a first UCI coded bit sequence according to one embodiment of the present application;

FIG. 9 illustrates a schematic diagram of relations among a first UCI coded bit sequence, multiple values, and a second parameter according to one embodiment of the present application;

FIG. 10 illustrates a schematic diagram of a length of a first UCI coded bit sequence according to one embodiment of the present application;

FIG. 11 illustrates a flowchart of the processing of a first node according to one embodiment of the present application;

FIG. 12 illustrates a flowchart of signal transmission according to one embodiment of the present application;

FIG. 13 illustrates a structure block diagram of a processor in a first node according to one embodiment of the present application;

FIG. 14 illustrates a structure block diagram of a processor in a second node according to one embodiment of the present application.

### DESCRIPTION OF THE EMBODIMENTS

The technical solution of the present application will be further described in detail below in combination with the drawings. It should be noted that, in the case of no conflict, the embodiments of the present application and the features in the embodiments may be combined with each other arbitrarily,

### Embodiment 1

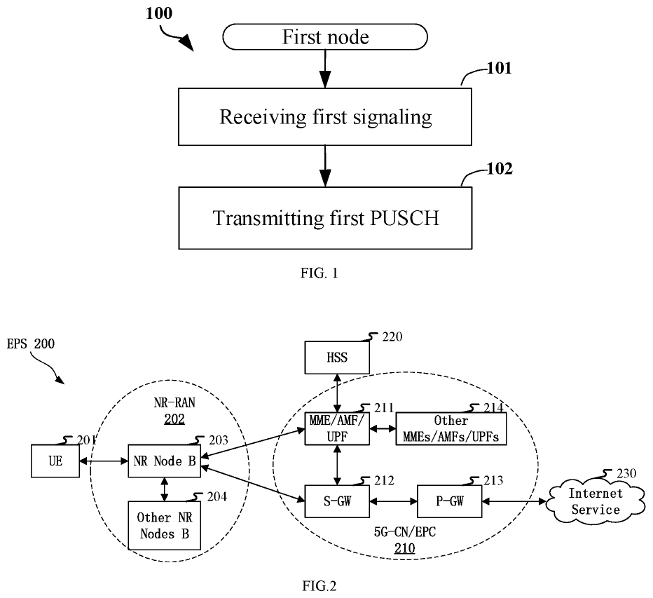

Embodiment 1 illustrates a flowchart of the processing of a first node according to one embodiment of the present application, as shown in FIG. 1.

In Embodiment 1, the first node in the present application receives a first signaling in step 101; transmits a PUSCH in step 102.

In embodiment 1, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the first PUSCH carries a target coded bit group, the target coded bit group comprises multiple coded bits; the first signaling is used to schedule the first PUSCH; a first UCI coded bit sequence comprises coded bits for UCI, a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one embodiment, the first signaling is an UpLink Grant Signalling.

In one embodiment, the first signaling is Downlink control information (DCI).

In one embodiment, the first signaling is a DCI format.

In one embodiment, the first signaling is DCI format 0_1.

In one embodiment, the first signaling is DCI format 0_2.

In one embodiment, the first signaling adopts one of DCI format 0_0, DCI format 0_1 or DCI format 0_2,

In one embodiment, the first signaling adopts a DCI format other than DCI format 0_0, DCI format 0_1 or DCI format 0_2.

In one embodiment, the first signaling is a DCI comprising UL grant.

In one embodiment, the first signaling comprises at least one field in a DCI format.

In one embodiment, the first signaling comprises a higher-layer parameter.

In one embodiment, the first signaling comprises an RRC signaling.

In one embodiment, the first signaling is dynamically configured.

In one embodiment, the first signaling comprises a layer 1 (L1) signaling.

In one embodiment, the first signaling comprises one or multiple fields in a physical-layer signaling.

In one embodiment, the first signaling comprises a higher-layer signaling.

In one embodiment, the first signaling comprises one or multiple fields in a higher-layer signaling.

In one embodiment, the first signaling comprises a Radio Resource Control (RRC) signaling.

In one embodiment, the first signaling comprises a Medium Access Control layer Control Element (MAC CE).

In one embodiment, the first signaling comprises one or multiple fields in an RRC signaling.

In one embodiment, the first signaling comprises one or multiple fields in a MAC CE.

In one embodiment, the first signaling comprises one or multiple fields in an Information Element (IE).

In one embodiment, the first signaling comprises Sidelink Control Information (SCI).

In one embodiment, the first signaling comprises one or multiple fields in an SCI.

In one embodiment, the first signaling is used to indicate the first parameter.

In one embodiment, the first signaling explicitly indicates the first parameter.

In one embodiment, the first signaling implicitly indicates the first parameter.

In one embodiment, the first signaling is used to configure the first parameter.

In one embodiment, the first signaling is used to indicate the second parameter.

In one embodiment, the first signaling explicitly indicates the second parameter.

In one embodiment, the first signaling implicitly indicates the second parameter.

In one embodiment, the first signaling is used to configure the second parameter.

In one embodiment, two Modulation and Coding Scheme (MCS) fields in the first signaling are respectively used to determine the first parameter and the second parameter.

In one embodiment, two Sounding reference signal (SRS) resource indicator fields in the first signaling are respectively used to determine the first parameter and the second parameter.

In one embodiment, two Precoding information and number of layers fields in the first signaling are respectively used to determine the first parameter and the second parameter.

In one embodiment, two Modulation and Coding Scheme (MCS) fields in the first signaling are respectively used to indicate the first parameter and the second parameter.

In one embodiment, two SRS resource indicator fields in the first signaling are respectively used to indicate the first parameter and the second parameter.

In one embodiment, two Precoding information and number of layers fields in the first signaling are respectively used to indicate the first parameter and the second parameter.

In one embodiment, the first parameter is an MCS-related parameter, and the second parameter is a number of transmission layer(s).

In one embodiment, the second parameter is an MCS-related parameter, and the first parameter is a number of transmission layer(s).

In one embodiment, the first parameter and the second parameter are respectively different MCS-related parameters.

In one embodiment, the first parameter and the second parameter are respectively indicated by two different modulations and coding scheme (MCS) fields in the first signaling.

In one embodiment, two fields in the first signaling are respectively used to indicate the first parameter and the second parameter, and the two fields in the first signaling are respectively for the two TBs.

In one embodiment, the first parameter is different from the second parameter.

In one embodiment, the MCS-related parameters refer to: parameters determined by a Modulation and Coding Scheme (MCS) field.

In one embodiment, modulation order and target code rate are both MCS-related parameters.

In one embodiment, the MCS-related parameter is one of modulation order and target code rate.

In one embodiment, the expression of “the first parameter and the second parameter being respectively for two TBs” comprises: the first parameter is used to determine a size of one of the two TBs. and the second parameter is used to determine a size of the other of the two TBs.

In one embodiment, the first parameter is a number of transmission layer(s) of one of the two TBs, and the second parameter is a number of transmission layer(s) of the other of the two TBs.

In one embodiment, the first parameter is a number of transmission layer(s) of one of the two TBs, and the second parameter is a number of transmission layer(s) of the other of the two TBs.

In one embodiment, the two TBs are respectively mapped to two codewords; the first parameter is a number of transmission layer(s) used to map a codeword corresponding to one of the two TBs, and the second parameter is a number of transmission layer(s) used to map a codeword corresponding to the other of the two TBs.

In one embodiment, the meaning of the expression of “transmitting a first PUSCH” comprises: transmitting a signal in the first Physical uplink shared channel (PUSCH).

In one embodiment, the meaning of the expression of “transmitting a first PUSCH” comprises: transmitting multiple bits in the first PUSCH.

In one embodiment, the meaning of the expression of “transmitting a first PUSCH” comprises: transmitting multiple codewords in the first PUSCH.

In one embodiment, the meaning of the expression of “transmitting a first PUSCH” is: transmitting a signal in the first PUSCH.

In one embodiment, the meaning of the expression of “the first PUSCH carrying a target coded bit group” is: the target coded bit set is multiplexed onto the first PUSCH.

In one embodiment, the meaning of the expression of “the first PUSCH carrying a target coded bit group” is: the target coded bit set is transmitted on the first PUSCH.

In one embodiment, the meaning of the expression of “the first PUSCH carrying a target coded bit group” comprises: the target coded bit set is transmitted through a signal on the first PUSCH.

In one embodiment, the meaning of the expression of “the first PUSCH carrying a target coded bit group” comprises: the target coded bit set is multiplexed onto the first PUSCH.

In one embodiment, the meaning of the expression of “the first PUSCH carrying a target coded bit group” comprises: the target coded bit group is transmitted on the first PUSCH after through at least part of Scrambling, Modulation, Layer mapping, Transform precoding, Precoding, Mapping to virtual resource blocks and Mapping from virtual to physical resource blocks.

In one embodiment, the target coded bit group is transmitted on the first PUSCH after through at least part of Scrambling, Modulation, Layer mapping, Transform precoding, Precoding, Mapping to virtual resource blocks and Mapping from virtual to physical resource blocks.

In one embodiment, the first signaling comprises scheduling information of the first PUSCH.

In one embodiment, the first signaling is used to indicate time-domain resources occupied by the first PUSCH.

In one embodiment, the first signaling is used to indicate frequency-domain resources occupied by the first PUSCH.

In one embodiment, the first UCI coded bit sequence comprises coded bits for at least one UCI.

In one embodiment, the first UCI coded bit sequence comprises coded bits for a Hybrid automatic repeat request acknowledgement (HARQ-ACK).

In one embodiment, the first UCI coded bit sequence comprises coded bits for Channel state information (CSI) part 1.

In one embodiment, the first UCI coded bit sequence comprises coded bits for CSI part 2.

In one embodiment, the first UCI coded bit sequence comprises coded bits for a UCI other than HARQ-ACK, CSI part 1, and CSI part 2.

In one embodiment, the first UCI coded bit sequence is coded bits for HARQ-ACK.

In one embodiment, the first UCI coded bit sequence is coded bits for CSI part 1.

In one embodiment, the first UCI coded bit sequence is coded bits for CSI part 2.

In one embodiment, the first UCI coded bit sequence is coded bits for a UCI other than HARQ-ACK, CSI part 1, and CSI part 2.

In one embodiment, the meaning of the expression of “a length of the first UCI coded bit sequence depends on the second parameter” is: the second parameter is used to determine a length of the first UCI coded bit sequence.

In one embodiment, the second parameter is used to determine a length of the first UCI coded bit sequence.

In one embodiment, the second parameter is used to calculate a length of the first UCI coded bit sequence.

In one embodiment, the second parameter is used to infer a length of the first UCI coded bit sequence.

In one embodiment, the second parameter is used to indicate a length of the first UCI coded bit sequence.

In one embodiment, the meaning of the expression of “the target coded bit group depending on the first UCI coded bit sequence” is: at least part of coded bits in the first UCI coded bit sequence is used to determine the target coded bit group.

In one embodiment, the target coded bit group comprises the first UCI coded bit sequence.

In one embodiment, the target coded bit group is obtained based on at least the first UCI coded bit sequence.

In one embodiment, the first UCI coded bit sequence is used to determine the target coded bit group.

In one embodiment, the target coded bit set is obtained based on a first process, and the first process comprises a first assignment operation and a second assignment operation; in the first assignment operation, a value of a coded bit in the first UCI coded bit sequence is assigned to a first intermediate bit; in the second assignment operation, a value of the first intermediate bit is assigned to a coded bit in the target coded bit group.

In one embodiment, a value of each coded bit in the first UCI coded bit sequence is assigned to a coded bit in the target coded bit group.

In one embodiment, the target coded bit group comprises a first target coded bit sequence and a second target coded bit sequence, the first target coded bit sequence and the second target coded bit sequence respectively comprise coded bits for the two TBs, and a value of each coded bit in the first UCI coded bit sequence is assigned to a coded bit in the first target coded bit sequence.

In one embodiment, at least one coded bit in the first UCI coded bit sequence is used to indicate a number of coded bits comprised in the target coded bit group.

In one embodiment, the meaning of the expression of “at least one of the target coded bit group or the first UCI coded bit sequence depending on a target HARQ-ACK bit block” is: a target HARQ-ACK bit block is used to determine at least one of the target coded bit group or the first UCI coded bit sequence.

In one embodiment, the meaning of the expression of “at least one of the target coded bit group or the first UCI coded bit sequence depending on a target HARQ-ACK bit block” is: a coded bit of a target HARQ-ACK bit block is used to determine at least one of the target coded bit group or the first UCI coded bit sequence.

In one embodiment, the target coded bit group depends on the target HARQ-ACK bit block.

In one embodiment, the target HARQ-ACK bit block is used to determine the target coded bit group.

In one embodiment, the meaning of the target coded bit group depending on the target HARQ-ACK bit block comprises: the target coded bit group depends on coded bits for the target HARQ-ACK bit block.

In one embodiment, the meaning of the target coded bit group depending on the target HARQ-ACK bit block is: the target coded bit group depends on coded bits for the target HARQ-ACK bit block.

In one embodiment, the target UCI coded bit group comprises coded bits for the target HARQ-ACK bit block.

In one embodiment, the target coded bit group is obtained based on coded bits of at least the target HARQ-ACK bit block.

In one embodiment, coded bits for the target HARQ-ACK bit block are used to determine the target coded bit group.

In one embodiment, the target coded bit set is obtained based on a first process, and the first process comprises a first assignment operation and a second assignment operation; in the first assignment operation, a value of a coded bit in coded bits for the target HARQ-ACK bit block is assigned to a first intermediate bit; in the second assignment operation, a value of the first intermediate bit is assigned to a coded bit in the target coded bit group.

In one embodiment, a value of each coded bit in coded bits for the target HARQ-ACK bit block is assigned to a coded bit in the target coded bit group.

In one embodiment, the target coded bit group comprises a first target coded bit sequence and a second target coded bit sequence, the first target coded bit sequence and the second target coded bit sequence respectively comprise coded bits for the two TBs, and a value of each coded bit in coded bits for the target HARQ-ACK bit block is assigned to a coded bit in the first target coded bit sequence.

In one embodiment, the target coded bit set is obtained based on a first process, and an execution of the first process depends on a number of HARQ-ACK bit(s) comprised in the target HARQ-ACK bit block.

In one embodiment, the target coded bit group is obtained based on at least one of multiple process steps, a target process step is one of the multiple process steps, and whether the target process step is executed depends on a number of HARQ-ACK bit(s) comprised in the target HARQ-ACK bit block.

In one embodiment, each step in the multiple process steps is a step used to obtain a multiplexed data and control coded bit sequence.

In one embodiment, the multiple process steps are multiple steps used to obtain multiplexed data and control coded bit sequences in section 6.2.7 of 3GPP TS 38.212.

In one embodiment, the target process step comprises at least one assignment operation.

In one embodiment, when the target condition is met, the target process step is executed; otherwise, the target process step is skipped.

In one embodiment, when the target condition is not met, the target process step is executed; otherwise, the target process step is skipped.

In one embodiment, at least one coded bit in coded bits for the target HARQ-ACK bit block is used to indicate a number of coded bits comprised in the target coded bit group.

In one embodiment, the first UCI coded bit sequence depends on the target HARQ-ACK bit block.

In one embodiment, the target HARQ-ACK bit block is used to determine the first UCI coded bit sequence.

In one embodiment, the first UCI coded bit sequence comprises coded bits for the target HARQ-ACK bit block.

In one embodiment, the first UCI coded bit sequence is coded bits for the target HARQ-ACK bit block.

In one embodiment, a number of HARQ-ACK bit(s) comprised in the target HARQ-ACK bit block is used to determine a length of the first UCI coded bit sequence.

In one embodiment, a number of HARQ-ACK bit(s) comprised in the target HARQ-ACK bit block is used to indicate a length of the first UCI coded bit sequence.

In one embodiment, a number of HARQ-ACK bit(s) comprised in the target HARQ-ACK bit block implicitly indicates a length of the first UCI coded bit sequence.

In one embodiment, a number of HARQ-ACK bit(s) comprised in the target HARQ-ACK bit block is used to limit a length of the first UCI coded bit sequence.

In one embodiment, the target coded bit group and the first UCI coded bit sequence both depend on the target HARQ-ACK bit block.

In one embodiment, the target HARQ-ACK bit block comprises up to 2 HARQ-ACK bits.

In one embodiment, the target HARQ-ACK bit block comprises up to 3 HARQ-ACK bits.

In one embodiment, the target HARQ-ACK bit block comprises up to 4 HARQ-ACK bits.

In one embodiment, the target HARQ-ACK bit block comprises up to 1706 HARQ-ACK bits.

In one embodiment, the meaning of the target condition being satisfied is: a number of HARQ-ACK bit(s) comprised in the target HARQ-ACK bit block is not greater than 2.

In one embodiment, the meaning of the target condition being satisfied is: a number of HARQ-ACK bit(s) comprised in the target HARQ-ACK bit block is not greater than a reference value; the reference value is a constant or a configurable positive integer.

In one embodiment, the meaning of the target condition being satisfied is: a number of HARQ-ACK bit(s) comprised in the target HARQ-ACK bit block is greater than a reference value; the reference value is a constant or a configurable positive integer.

In one embodiment, the meaning of the target condition being satisfied is: a number of HARQ-ACK bit(s) comprised in the target HARQ-ACK bit block is not less than a reference value; the reference value is a constant or a configurable positive integer.

In one embodiment, the meaning of the target condition being satisfied is: a number of HARQ-ACK bit(s) comprised in the target HARQ-ACK bit block is less than a reference value; the reference value is a constant or a configurable positive integer.

In one embodiment, the reference value is 2.

In one embodiment, the reference value is 3.

In one embodiment, the reference value is 4.

In one embodiment, the reference value is 11.

In one embodiment, the reference value is 12.

In one embodiment, the reference value is not greater than 24.

In one embodiment, the reference value is configured by a higher-layer parameter.

In one embodiment, the reference value is configured by an RRC-layer parameter.

In one embodiment, the target condition is: a number of HARQ-ACK bit(s) comprised in the target HARQ-ACK bit block is fixed.

In one embodiment, the target condition is a condition related to a size relation between a number of HARQ-ACK bit(s) comprised in the target HARQ-ACK bit block and 2.

In one embodiment, the target condition is a condition related to a size relation between a number of HARQ-ACK bit(s) comprised in the target HARQ-ACK bit block and a reference value, and the reference value is a constant or configurable positive integer.

In one embodiment, the target condition comprises: a number of HARQ-ACK bit(s) comprised in the target HARQ-ACK bit block is not greater than 2.

In one embodiment, the target condition comprises: a number of HARQ-ACK bit(s) comprised in the target HARQ-ACK bit block is not greater than a reference value; the reference value is a constant or a configurable positive integer.

In one embodiment, the target condition comprises: a number of HARQ-ACK bit(s) comprised in the target HARQ-ACK bit block is greater than a reference value; the reference value is a constant or a configurable positive integer.

In one embodiment, the target condition comprises: a number of HARQ-ACK bit(s) comprised in the target HARQ-ACK bit block is not less than a reference value; the reference value is a constant or a configurable positive integer.

In one embodiment, the target condition comprises: a number of HARQ-ACK bit(s) comprised in the target HARQ-ACK bit block is less than a reference value; the reference value is a constant or a configurable positive integer,

In one embodiment, the target condition is: a number of HARQ-ACK bit(s) comprised in the target HARQ-ACK bit block is not greater than 2.

In one embodiment, the target condition comprises multiple sub-conditions, and the target condition being satisfied refers to that all sub-conditions comprised in the target condition are satisfied; one of the multiple sub-conditions is: a number of HARQ-ACK bit(s) comprised in the target HARQ-ACK bit block is not greater than 2; another one of the multiple sub-conditions is: the first PUSCH does not carry a Configured Grant (CG)-UCI.

In one embodiment, the target condition comprises multiple sub-conditions, and the target condition being satisfied refers to that all sub-conditions comprised in the target condition are satisfied; one of the multiple sub-conditions is: a number of HARQ-ACK bit(s) comprised in the target HARQ-ACK bit block is not greater than a reference value, and the reference value is a constant or a configurable positive integer; another one of the multiple sub-conditions is: the first PUSCH does not carry a CG-UCI.

In one embodiment, the expression of “the target coded bit group depending on a first reserved resource pool” comprises: the first reserved resource pool is used to determine the target coded bit group.

In one embodiment, the meaning of the expression of “the target coded bit group depending on a first reserved resource pool” is: the first reserved resource pool is used to determine the target coded bit group.

In one embodiment, when the target condition is met, the first reserved resource pool is used to indicate at least part of coded bits in the target coded bit group.

In one embodiment, when the target condition is met, the first reserved resource pool is used to indicate an order of coded bits in the target coded bit group.

In one embodiment, the target coded bit set is obtained based on a first process; when the target condition is met, the first process comprises a third assignment operation and a fourth assignment operation; in the third assignment operation, a value of a coded bit in the target HARQ-ACK bit block is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the target coded bit group.

In one embodiment, the target coded bit set is obtained based on a first process; when the target condition is met, the first process comprises a third assignment operation and a fourth assignment operation; in the third assignment operation, a value of a coded bit in the first UCI coded bit sequence is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the target coded bit group.

In one embodiment, the first target index is used to indicate a first sorting position, and a value of the intermediate bit corresponding to the first target index is assigned to a coded bit with a sorting position being the first sorting position in the target coded bit group.

In one embodiment, the target coded bit set is obtained based on a first process; when the target condition is met, the first process comprises a fifth assignment operation and a sixth assignment operation; in the fifth assignment operation, a value of a coded bit in the first UCI coded bit sequence is assigned to an intermediate bit corresponding to the second target index, and the second target index is a subcarrier index of a resource element in a first intermediate resource element set, and the first reserved resource pool is used to determine the first intermediate resource element set; in the sixth assignment operation, a value of the intermediate bit corresponding to the second target index is assigned to a coded bit in the target coded bit group.

In one embodiment, the first intermediate resource element set comprises at least one resource element (RE).

In one embodiment, the first intermediate resource element set is a part of a first reference resource element set after removing a second reference resource element set; the first reference resource element set comprises all or part of resource elements available for UCI transmission in at least one Orthogonal Frequency Division Multiplex (OFDM) symbol set, and the second reference resource element set comprises all or part of resource elements in the first reserved resource pool.

In one embodiment, the second target index is used to indicate a second sorting position, and a value of the intermediate bit corresponding to the second target index is assigned to a coded bit with a sorting position being the second sorting position in the target coded bit group.

In one embodiment, the expression of “the target coded bit group depending on a first reserved resource pool” comprises: a number of resource element(s) comprised in the first reserved resource pool is used to determine the target coded bit group.

In one embodiment, the meaning of the expression of “the target coded bit group depending on a first reserved resource pool” is: a number of resource element(s) comprised in the first reserved resource pool is used to determine the target coded bit group.

In one embodiment, when the target condition is met, a number of resource element(s) comprised in the first reserved resource pool is used to indicate the target coded bit group.

In one embodiment, when the target condition is met, a number of resource element(s) comprised in the first reserved resource pool is used to determine the first target index.

In one embodiment, when the target condition is met, a number of resource element(s) comprised in the first reserved resource pool is used to determine the second target index.

In one embodiment, when the target condition is met, a number of resource element(s) comprised in the first reserved resource pool is used to indicate the first target index.

In one embodiment, when the target condition is met, a number of resource element(s) comprised in the first reserved resource pool is used to indicate the second target index.

In one embodiment, when the target condition is met, a number of resource element(s) comprised in the first reserved resource pool is used to indicate a second interval, the second interval being a positive integer, the second target index is a subcarrier index of a J2-th resource element in the first intermediate resource element set, and the J2 is a non-negative integral multiple of the second interval.

In one embodiment, when the target condition is met, a number of resource element(s) comprised in the first reserved resource pool is used to indicate a third interval, the third interval being a positive integer, the first target index is a subcarrier index of a J1-th resource element in the first reserved resource pool, and the JI is a non-negative integral multiple of the third interval.

In one embodiment, the expression of “the target coded bit group depending on a first reserved resource pool” comprises: at least a part of the target coded bit group depends on the first reserved resource pool.

In one embodiment, the expression of “the target coded bit group depending on a first reserved resource pool” comprises: the first reserved resource pool is used to determine at least part of bits in the target coded bit group.

In one embodiment, the meaning of the expression of “the target coded bit group depending on a first reserved resource pool” is: the first reserved resource pool is used to determine at least part of bits in the target coded bit group.

In one embodiment, the meaning of the expression of “the target coded bit group depending on a first reserved resource pool” is: a generation of the target coded bit group depends on a first reserved resource pool.

In one embodiment, the meaning of the expression of “the target coded bit group depending on a first reserved resource pool” is: an acquisition of the target coded bit group depends on a first reserved resource pool.

In one embodiment, when the target condition is met, the first reserved resource pool is used to indicate an order of at least part of bits in the target coded bit group.

In one embodiment, the target coded bit group comprises a first target coded bit sequence and a second target coded bit sequence, the first target coded bit sequence and the second target coded bit sequence respectively comprise coded bits for the two TBs; when the target condition is met, the second target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool, the second target coded bit sequence depends on the first reserved resource pool.

In one embodiment, the expression of “the first target coded bit sequence depending on the first reserved resource pool” comprises: the first reserved resource pool is used to determine the first target coded bit sequence.

In one embodiment, the meaning of the expression of “the first target coded bit sequence depending on the first reserved resource pool” is: the first reserved resource pool is used to determine the first target coded bit sequence.

In one embodiment, when the target condition is met, the first reserved resource pool is used to indicate at least part of coded bits in the first target coded bit sequence.

In one embodiment, when the target condition is met, the first reserved resource pool is used to indicate an order of coded bits in the first target coded bit sequence.

In one embodiment, the first target coded bit sequence is obtained based on a first process; when the target condition is met, the first process comprises a third assignment operation and a fourth assignment operation; in the third assignment operation, a value of a coded bit in the target HARQ-ACK bit block is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the first target coded bit sequence.

In one embodiment, the first target coded bit sequence is obtained based on a first process; when the target condition is met, the first process comprises a third assignment operation and a fourth assignment operation; in the third assignment operation, a value of a coded bit in the first UCI coded bit sequence is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the first target coded bit sequence.

In one embodiment, the first target index is used to indicate a first sorting position, and a value of the intermediate bit corresponding to the first target index is assigned to a coded bit with a sorting position being the first sorting position in the first target coded bit sequence.

In one embodiment, the first target coded bit sequence is obtained based on a first process; when the target condition is met, the first process comprises a fifth assignment operation and a sixth assignment operation; in the fifth assignment operation, a value of a coded bit in the first UCI coded bit sequence is assigned to an intermediate bit corresponding to the second target index, and the second target index is a subcarrier index of a resource element in a first intermediate resource element set, and the first reserved resource pool is used to determine the first intermediate resource element set; in the sixth assignment operation, a value of the intermediate bit corresponding to the second target index is assigned to a coded bit in the first target coded bit sequence.

In one embodiment, the first intermediate resource element set comprises at least one resource element.

In one embodiment, the first intermediate resource element set is a part of a first reference resource element set after removing a second reference resource element set; the first reference resource element set comprises all or part of resource elements available for UCI transmission in at least one OFDM symbol set, and the second reference resource element set comprises all or part of resource elements in the first reserved resource pool.

In one embodiment, the second target index is used to indicate a second sorting position, and a value of the intermediate bit corresponding to the second target index is assigned to a coded bit with a sorting position being the second sorting position in the first target coded bit sequence.

In one embodiment, the expression of “the first target coded bit sequence depending on a first reserved resource pool” comprises: a number of resource element(s) comprised in the first reserved resource pool is used to determine the first target coded bit sequence.

In one embodiment, the meaning of the expression of “the first target coded bit sequence depending on a first reserved resource pool” is: a number of resource element(s) comprised in the first reserved resource pool is used to determine the first target coded bit sequence.

In one embodiment, when the target condition is met, a number of resource element(s) comprised in the first reserved resource pool is used to indicate the first target coded bit sequence.

In one embodiment, when the target condition is met, a number of resource element(s) comprised in the first reserved resource pool is used to determine the target coded bit group.

In one embodiment, when the target condition is met, a number of resource element(s) comprised in the first reserved resource pool is used to determine the second target index.

In one embodiment, when the target condition is met, a number of resource element(s) comprised in the first reserved resource pool is used to indicate the first target index.

In one embodiment, when the target condition is met, a number of resource element(s) comprised in the first reserved resource pool is used to indicate the second target index.

In one embodiment, when the target condition is met, a number of resource element(s) comprised in the first reserved resource pool is used to indicate a second interval, the second interval being a positive integer, the second target index is a subcarrier index of a J2-th resource element in the first intermediate resource element set, and the J2 is a non-negative integral multiple of the second interval.

In one embodiment, when the target condition is met, a number of resource element(s) comprised in the first reserved resource pool is used to indicate a third interval, the third interval being a positive integer, the first target index is a subcarrier index of a J1-th resource element in the first reserved resource pool, and the JI is a non-negative integral multiple of the third interval.

In one embodiment, the expression of “the second target coded bit sequence depending on the first reserved resource pool” comprises: the first reserved resource pool is used to determine the second target coded bit sequence.

In one embodiment, the meaning of the expression of “the second target coded bit sequence depending on the first reserved resource pool” is: the first reserved resource pool is used to determine the second target coded bit sequence.

In one embodiment, when the target condition is met, the first reserved resource pool is used to indicate at least part of coded bits in the second target coded bit sequence.

In one embodiment, when the target condition is met, the first reserved resource pool is used to indicate an order of coded bits in the second target coded bit sequence.

In one embodiment, the second target coded bit sequence is obtained based on a second process; when the target condition is met, the second process comprises a seventh assignment operation and an eighth assignment operation; in the seventh assignment operation, a value of a coded bit in coded bits for the target HARQ-ACK bit block is assigned to an intermediate bit corresponding to a third target index, and the third target index is a subcarrier index of a resource element in the first reserved resource pool; in the eighth assignment operation, a value of the intermediate bit corresponding to the third target index is assigned to a coded bit in the second target coded bit sequence.

In one embodiment, the second target coded bit sequence is obtained based on a second process; when the target condition is met, the second process comprises a seventh assignment operation and an eighth assignment operation; in the seventh assignment operation, a value of a coded bit in the first UCI coded bit sequence is assigned to an intermediate bit corresponding to a third target index, and the third target index is a subcarrier index of a resource element in the first reserved resource pool; in the eighth assignment operation, a value of the intermediate bit corresponding to the third target index is assigned to a coded bit in the second target coded bit sequence.

In one embodiment, the third target index is used to indicate a third sorting position, and a value of the intermediate bit corresponding to the third target index is assigned to a coded bit with a sorting position being the third sorting position in the second target coded bit sequence.

In one embodiment, the second target coded bit sequence is obtained based on a second process; when the target condition is met, the second process comprises a ninth assignment operation and a tenth assignment operation; in the ninth assignment operation, a value of a coded bit in the first UCI coded bit sequence is assigned to an intermediate bit corresponding to a fourth target index, the fourth target index is a subcarrier index of a resource element in a second intermediate resource element set, and the first reserved resource pool is used to determine the second intermediate resource element set; in the tenth assignment operation, a value of the intermediate bit corresponding to the fourth target index is assigned to a coded bit in the second target coded bit sequence.

In one embodiment, the second intermediate resource element set comprises at least one resource element.

In one embodiment, the second intermediate resource element set is a part of a third reference resource element set after removing a fourth reference resource element set; the third reference resource element set comprises all or part of resource elements in a set of resource elements available for UCI transmission in at least one OFDM symbol set, and the fourth reference resource element set comprises all or part of resource elements in the first reserved resource pool.

In one embodiment, the fourth target index is used to indicate a fourth sorting position, and a value of the intermediate bit corresponding to the fourth target index is assigned to a coded bit with a sorting position being the fourth sorting position in the second target coded bit sequence.

In one embodiment, the expression of “the second target coded bit sequence depending on a first reserved resource pool” comprises: a number of resource element(s) comprised in the first reserved resource pool is used to determine the second target coded bit sequence.

In one embodiment, the meaning of the expression of “the second target coded bit sequence depending on a first reserved resource pool” is: a number of resource element(s) comprised in the first reserved resource pool is used to determine the second target coded bit sequence.

In one embodiment, when the target condition is met, a number of resource element(s) comprised in the first reserved resource pool is used to indicate the second target coded bit sequence.

In one embodiment, when the target condition is met, a number of resource element(s) comprised in the first reserved resource pool is used to determine the third target index.

In one embodiment, when the target condition is met, a number of resource element(s) comprised in the first reserved resource pool is used to determine the fourth target index.

In one embodiment, when the target condition is met, a number of resource element(s) comprised in the first reserved resource pool is used to indicate the third target index.

In one embodiment, when the target condition is met, a number of resource element(s) comprised in the first reserved resource pool is used to indicate the fourth target index.

In one embodiment, when the target condition is met, a number of resource element(s) comprised in the first reserved resource pool is used to indicate a fourth interval, the fourth interval being a positive integer, the fourth target index is a subcarrier index of an J4-th resource element in the second intermediate resource element set, and the J4 is a non-negative integral multiple of the fourth interval.

In one embodiment, when the target condition is met, a number of resource element(s) comprised in the first reserved resource pool is used to indicate a fifth interval, the fifth interval being a positive integer, the third target index is a subcarrier index of an J3-th resource element in the first reserved resource pool, and J3 is a non-negative integral multiple of the fifth interval.

In one embodiment, when the target condition is satisfied: the first parameter is used to indicate the first reserved resource pool.

In one embodiment, when the target condition is satisfied: the first parameter is used to indicate a number of resource element(s) comprised in the first reserved resource pool.

In one embodiment, when the target condition is satisfied: the first parameter explicitly indicates the first reserved resource pool.

In one embodiment, when the target condition is satisfied: the first parameter implicitly indicates the first reserved resource pool.

In one embodiment, when the target condition is satisfied: the first parameter is used to configure the first reserved resource pool.

In one embodiment, the length of the first UCI coded bit sequence also depends on the first parameter.

In one embodiment, the length of the first UCI coded bit sequence depends on only latter of the first parameter and the second parameter.

In one embodiment, the first PUSCH is used to transmit the two TBs.

In one embodiment, the two TBs are transmitted on the first PUSCH.

In one embodiment, the first signaling is used to schedule a transmission of the two TBs on the first PUSCH.

In one embodiment, each of the two TBs is transmitted on the first PUSCH after through at least partial scrambling, modulation, layer mapping, antenna port mapping, mapping to virtual resource blocks, mapping from virtual resource blocks to physical resource blocks, multicarrier symbol generation or modulation upconversion.

In one embodiment, each of the two TBs is transmitted on the first PUSCH after through at least partial of CRC attachment, Code block segmentation, Code block CRC attachment, Channel coding, Rate matching, Code block concatenation, Scrambling, Modulation, Layer mapping, Transform precoding, Precoding, Mapping to virtual resource blocks, mapping from virtual to physical resource blocks, multicarrier symbol generation and modulation upconversion.

In one embodiment, each of the two TBs is transmitted on the first PUSCH after through at least partial of CRC attachment, Code block segmentation, Code block CRC attachment, Channel coding, Rate matching, Code block concatenation, Scrambling, Modulation, Layer mapping, Antenna port mapping, Precoding, Mapping to virtual resource blocks, mapping from virtual to physical resource blocks, multicarrier symbol generation and modulation upconversion.

In one embodiment, each of the two TBs is transmitted on the first PUSCH after through at least partial of CRC attachment, Code block segmentation, Code block CRC attachment, Channel coding, Rate matching, Code block concatenation, Scrambling, Modulation, Layer mapping, precoding, Antenna port mapping, Mapping to virtual resource blocks, mapping from virtual to physical resource blocks, multicarrier symbol generation and modulation upconversion.

In one embodiment, when the target condition is met, the first reserved resource pool is a set of reserved resource elements for potential HARQ-ACK transmission.

In one embodiment, when the target condition is met, the first reserved resource pool is a set of reserved resource elements for potential HARQ-ACK transmission in at least one OFDM symbol.

In one embodiment, reserved resource elements used for potential HARQ-ACK transmission are: resource elements reserved for a HARQ-ACK transmission.

In one embodiment, reserved resource elements used for potential HARQ-ACK transmission are: resource elements reserved for a possible HARQ-ACK transmission.

In one embodiment, reserved resource elements used for potential HARQ-ACK transmission are: resource elements reserved for a potential transmission of not exceeding 2 HARQ-ACK bits.

In one embodiment, the first parameter is a modulation order of one of the two TBs, and the second parameter is a modulation order of the other of two TBs.

In one embodiment, the first parameter is a target code rate of one of the two TBs, and the second parameter is a target code rate of the other of the two TBs.

In one embodiment, the first parameter is a number of transmission layer(s) of one of the two TBs, and the second parameter is a number of transmission layer(s) of the other of the two TBs.

In one embodiment, the meaning of the expression of “only when the target condition is met, the first parameter being used to determine the first reserved resource pool” comprises: when the target condition is not met, the first reserved resource pool is an empty set.

In one embodiment, the meaning of the expression of “only when the target condition is met, the first parameter being used to determine the first reserved resource pool” is: when the target condition is not met, the first reserved resource pool is an empty set.

In one embodiment, the meaning of the expression of “only when the target condition is met, the first parameter being used to determine the first reserved resource pool” comprises: when the target condition is not met, the first reserved resource pool is always an empty set.

In one embodiment, the meaning of the expression of “only when the target condition is met, the first parameter being used to determine the first reserved resource pool” is: when the target condition is not met, the first reserved resource pool is always an empty set.

In one embodiment, the meaning of the expression of “only when the target condition is met, the first parameter being used to determine the first reserved resource pool” comprises: when the target condition is not met, the first reserved resource pool is pre-configured.

In one embodiment, the meaning of the expression of “only when the target condition is met, the first parameter being used to determine the first reserved resource pool” is: when the target condition is not met, the first reserved resource pool is pre-configured.

In one embodiment, the meaning of the expression of “only when the target condition is met, the first parameter being used to determine the first reserved resource pool” comprises: when the target condition is not met, the first reserved resource pool does not change with a change of the first parameter.

In one embodiment, the meaning of the expression of “only when the target condition is met, the first parameter being used to determine the first reserved resource pool” comprises: when the target condition is not met, the first reserved resource pool does not depend on the first parameter.

In one embodiment, the meaning of the expression of “only when the target condition is met, the first parameter being used to determine the first reserved resource pool” comprises: when the target condition is not met, the first node does not need to know information of the first parameter for determining the first reserved resource pool.

In one embodiment, the target condition comprises: a number of HARQ-ACK bit(s) comprised in the target HARQ-ACK bit block is not greater than a reference value, and the reference value is a constant or a configurable positive integer.

In one embodiment, when the target condition is met, the first reserved resource pool is a set of reserved resource elements for potential HARQ-ACK transmission in at least one OFDM symbol.

In one embodiment, when the target condition is met, the first reserved resource pool is a set of reserved resource elements used for potential HARQ-ACK transmission in an OFDM symbol.

In one embodiment, the target condition comprises that a number of HARQ-ACK bit(s) comprised in the target HARQ-ACK bit block is not greater than 2.

In one embodiment, at least a part of the target coded bit group depends on the first UCI coded bit sequence.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The NR 5G or LTE network architecture 200 may be called an Evolved Packet System (EPS) 200 or other appropriate terms. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms, The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212, the S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the UE 201 corresponds to the second node in the present application.

In one embodiment, the UE 201 is a UE.

In one embodiment, the UE 201 is a UE supporting multicast.

In one embodiment, the UE 201 is a regular UE.

In one embodiment, the gNB 203 corresponds to the first node in the present application.

In one embodiment, the gNB 203 corresponds to the second node in the present application.

In one embodiment, the UE 201 corresponds to the first node in the present application, and the gNB 203

corresponds to the second node in the present application.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a base station that enables network energy saving enhancement.

In one embodiment, both the first node and the second node in the present application correspond to the UE 201, for example, V2X communications are executed between the first node and the second node.

### Embodiment 3

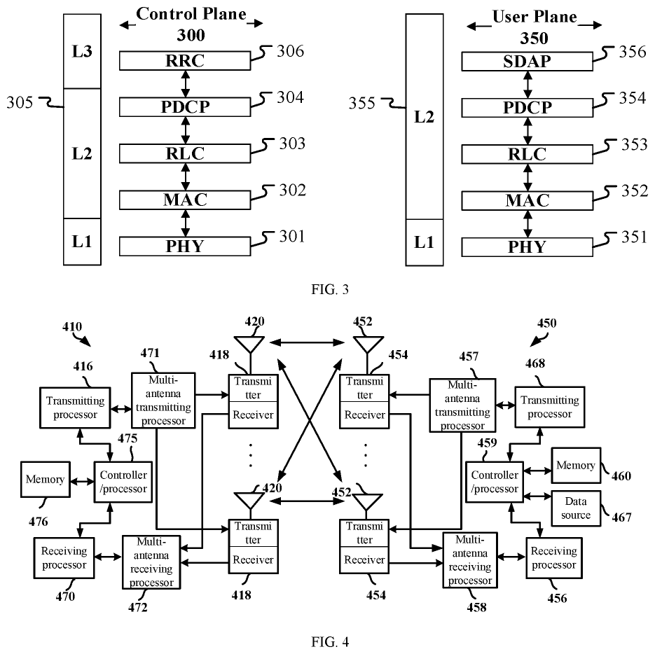

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC sublayer 306.

In one embodiment, the first signaling in the present application is generated by the MAC sublayer 302.

In one embodiment, the first signaling in the present application is generated by the PHY 301.

In one embodiment, the first PUSCH in the present application is generated by the PHY 301.

### Embodiment 4

Embodiment 4 illustrates a schematic diagram of a first communication device and a second communication device in the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In the transmission from the first communication device 410 to the first communication device 450, the controller/processor 475 provides header compression, encryption, packet segmentation and reordering, and multiplexing between a logical channel and a transport channel, and radio resources allocation to the second communication device 450 based on various priorities. The controller/processor 475 is also responsible for retransmission of a lost packet and a signaling to the second communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the second communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication device 410 to the second communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the second communication device 450 to the first communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first node in the present application comprises the second communication device 450, and the second node in the present application comprises the first communication device 410.

In one subembodiment of the above embodiment, the first node is a UE, and the second node is a UE.

In one subembodiment of the above embodiment, the first node is a UE, and the second node is a relay node.

In one subembodiment of the above embodiment, the first node is a relay node, and the second node is a UE.

In one subembodiment of the above embodiment, the first node is a UE, and the second node is a base station.

In one subembodiment of the above embodiment, the first node is a relay node, and the second node is a base station.

In one subembodiment of the above embodiment, the second node is a UE, and the first node is a base station.

In one subembodiment of the above embodiment, the second node is a relay node, and the first node is a base station.

In one subembodiment of the above embodiment, the second communication device 450 comprises: at least one controller/processor; the at least one controller/processor is responsible for HARQ operation.

In one subembodiment of the above embodiment, the first communication device 410 comprises: at least one controller/processor; the at least one controller/processor is responsible for HARQ operation.

In one subembodiment of the above embodiment, the first communication device 410 comprises: at least one controller/processor; the at least one controller/processor is responsible for error detection using ACK and/or NACK protocols as a way to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); transmits a first PUSCH, the first PUSCH carries a target coded bit group, the target coded bit group comprises multiple coded bits; herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); transmitting a first PUSCH, the first PUSCH carrying a target coded bit group, the target coded bit group comprising multiple coded bits; herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); receives a first PUSCH, the first PUSCH carries a target coded bit group, the target coded bit group comprises multiple coded bits; herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); receiving a first PUSCH, the first PUSCH carrying a target coded bit group, the target coded bit group comprising multiple coded bits; herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one subembodiment of the above embodiment, the first communication device 410 corresponds to the second node in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); transmits a first PUSCH, the first PUSCH carries a target coded bit group, the target coded bit group comprises multiple coded bits; herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one subembodiment of the above embodiment, the second communication device 450 corresponds to the first node in the present application.

In one embodiment, the second communication device 450 comprises a memory that stores a computer readable instruction program. The computer readable instruction program generates an action when executed by at least one processor. The action includes: receiving a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); transmitting a first PUSCH, the first PUSCH carrying a target coded bit group, the target coded bit group comprising multiple coded bits; herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one subembodiment of the above embodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); receives a first PUSCH, the first PUSCH carries a target coded bit group, the target coded bit group comprises multiple coded bits; herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one subembodiment of the above embodiment, the first communication device 410 corresponds to the second node in the present application.

In one embodiment, the first communication device 410 comprises a memory that stores a computer readable instruction program. The computer readable instruction program generates an action when executed by at least one processor. The action includes: transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); receiving a first PUSCH, the first PUSCH carrying a target coded bit group, the target coded bit group comprising multiple coded bits; herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one subembodiment of the above embodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used to receive the first signaling in the present application.

In one embodiment, at least one of the antenna 420, the transmitter 418, the multi-antenna transmitting processor 471, the transmitting processor 416, the controller/processor 475, or the memory 476 is used to transmit the first signaling in the present application.

In one embodiment, at least one of the antenna 452, the transmitter 454, the multi-antenna transmitting processor 458, the transmitting processor 468, the controller/processor 459, the memory 460, or the data sources 467 is used to transmit the first PUSCH in the present application.

In one embodiment, at least one of the antenna 420, the receiver 418, the multi-antenna receiving processor 472, the receiving processor 470, the controller/processor 475, or the memory 476 is used to receive the first PUSCH in the present application.

### Embodiment 5

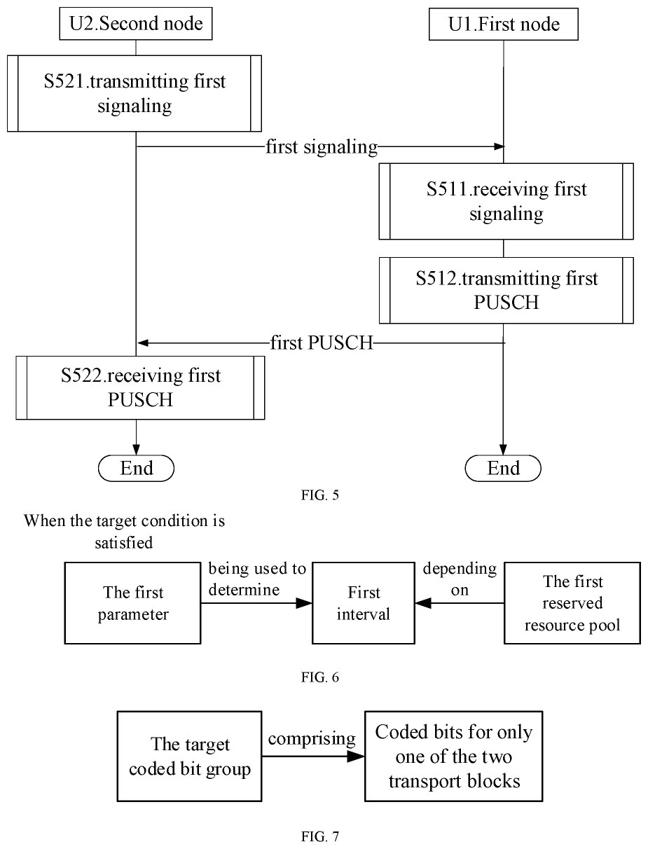

Embodiment 5 illustrates a flowchart of signal transmission according to one embodiment in the present application, as shown in FIG. 5. In FIG. 5, a first node U1 and a second node U2 are in communications via an air interface.

The first node U1 receives a first signaling in step S511; transmits a first PUSCH in step S512.

The second node U2 transmits a first signaling in step S521; receives a first PUSCH in step S522.

In embodiment 5, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the first PUSCH carries a target coded bit group, the target coded bit group comprises multiple coded bits; the first signaling is used to schedule the first PUSCH; a first UCI coded bit sequence comprises coded bits for UCI, and a length of the first UCI coded bit sequence depends on the second parameter, the length of the first UCI coded bit sequence is equal to a product of multiple values, the multiple values are non-negative integers, one of the multiple values is the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first interval, the first interval being a positive integer, the first reserved resource pool depends on the first interval, and the first reserved resource pool comprises reserved resource elements for potential HARQ-ACK transmission; only when the target condition is met, the first parameter is used to determine the first reserved resource pool; the target condition comprises: a number of HARQ-ACK bit(s) comprised in the target HARQ-ACK bit block is not greater than 2.

In one subembodiment of embodiment 5, the first parameter is a modulation order of one of the two TBs, and the second parameter is a modulation order of the other of two TBs; when the target condition is not met, the first reserved resource pool is an empty set.

In one subembodiment of embodiment 5, the first parameter is a target code rate of one of the two TBs, and the second parameter is a target code rate of the other of the two TBs; when the target condition is not met, the first reserved resource pool is an empty set.

In one subembodiment of embodiment 5, the first parameter is a number of transmission layer(s) of one of the two TBs, and the second parameter is a number of transmission layer(s) of the other of the two TBs; when the target condition is not met, the first reserved resource pool is an empty set.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 comprises a cellular link.

In one embodiment, an air interface between the second node U2 and the first node U1 is a PC5 interface. In one embodiment, an air interface between the second node U2 and the first node U1 comprises a sidelink.

In one embodiment, an air interface between the second node U2 and the first node U1 comprises a radio interface between a base station and a UE.

In one embodiment, an air interface between the second node U2 and the first node U1 comprises a radio interface between a satellite and a UE.

In one embodiment, an air interface between the second node U2 and the first node U1 comprises a radio interface between a UE and a UE.

In one embodiment, a problem to be solved in the present application comprises: how to determine the target coded bit group based on the first parameter and the second parameter.

In one embodiment, a problem to be solved in the present application comprises: how to determine relations among the first parameter, the second parameter, the first reserved resource pool, the first UCI coded bit sequence. and the target coded bit group.

In one embodiment, a problem to be solved in the present application comprises: how to determine a set of reserved resource elements used for potential HARQ-ACK transmission.

In one embodiment, a problem to be solved in the present application comprises: how to optimize the resource allocation between the multiplexed UCI and a TB for a PUSCH carrying two TBs.

In one embodiment, a problem to be solved in the present application comprises: how to improve the resource utilization rate of the PUSCH.

In one embodiment, a problem to be solved in the present application comprises: how to improve the performance of UCI feedback.

In one embodiment, a problem to be solved in the present application comprises: how to improve the transmission performance of a UL-SCH.

In one embodiment, a problem to be solved in the present application comprises: how to improve the transmission performance of UCI or a UL-SCH using spatial diversity gain.

In one embodiment, a problem to be solved in the present application comprises: how to improve the transmission performance of a PUSCH that multiplexes UCI in the multi-Multiple Transmit/Receive Point (TRP) scenario.

In one embodiment, a problem to be solved in the present application comprises: how to improve the transmission performance of a PUSCH that multiplexes UCI in the Single Transmit/Receive Point (s-TRP) scenario.

In one embodiment, a problem to be solved in the present application comprises: how to improve the transmission performance of a PUSCH that multiplexes UCI in the Multiple Input Multiple Output (MIMO) scenario.

### Embodiment 6

Embodiment 6 illustrate a schematic diagram of relations among a first parameter, a first interval and a first reserved resource pool when a target condition is satisfied according to one embodiment of the present application, as shown in FIG. 6.

In embodiment 6, when the target condition is satisfied: the first parameter is used to determine a first interval, the first interval is a positive integer, and the first reserved resource pool depends on the first interval.

In one embodiment, the expression of “the first reserved resource pool depending on the first interval” comprises: the first interval is used to determine the first reserved resource pool.

In one embodiment, the meaning of the expression of “the first reserved resource pool depending on the first interval” is: the first interval is used to determine the first reserved resource pool.

In one embodiment, when the target condition is satisfied: the first interval is used to indicate the first reserved resource pool comprises which resource elements in a first reserved resource pool; the first resource element set comprises a set of resource element(s) available for data transmission in at least one OFDM symbol.

In one embodiment, when the target condition is satisfied: the first reserved resource pool comprises an J-th resource element in a first resource element set, where J is a non-negative integral multiple of the first interval; the first resource element set comprises a set of resource element(s) available for data transmission in at least one OFDM symbol.

In one embodiment, when the target condition is satisfied: the first parameter is used to indicate the first interval.

In one embodiment, when the target condition is satisfied: the first parameter explicitly indicates the first interval.

In one embodiment, when the target condition is satisfied: the first parameter implicitly indicates the first interval.

In one embodiment, when the target condition is satisfied: the first parameter is used to configure the first interval.

In one embodiment, when the target condition is satisfied: the first parameter is used to determine a first reference number, the first reference number is used to determine a first interval, the first interval is a positive integer, and the first reserved resource pool depends on the first interval.

In one embodiment, when the target condition is satisfied: a first reference number depends on a number of reserved resource element(s) used for potential HARQ-ACK transmission, the first reference number, together with the first parameter, is used to determine the first interval, the first interval being a positive integer, and the first reserved resource pool depends on the first interval.

In one embodiment, when the target condition is satisfied: a first reference number is related to a number of reserved resource element(s) used for potential HARQ-ACK transmission, the first reference number, together with the first parameter, is used to determine the first interval, the first interval being a positive integer, and the first reserved resource pool depends on the first interval.

In one embodiment, the first reference number is a number of coded bit(s) for potential HARQ-ACK transmission using the reserved resource elements.

In one embodiment, the first reference number is not greater than a number of coded bit(s) for potential HARQ-ACK transmission using reserved resource elements.

In one embodiment, when the target condition is satisfied: a first reference number is used to determine the first interval.

In one embodiment, when the target condition is satisfied: a first reference number and the first parameter are used to determine the first interval.

In one embodiment, when the target condition is satisfied: the first reference number and the first parameter are used together to indicate the first interval.

In one embodiment, when the target condition is satisfied: the first reference number and the first parameter are used together to obtain the first interval through executing judgment.

In one embodiment, when the target condition is satisfied: the first reference number is used to determine the first interval.

In one embodiment, when the target condition is satisfied: the first reference number is used to indicate the first interval.

In one embodiment, when the target condition is satisfied: the first reference number is used to obtain the first interval through executing judgment.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) in one of the two TBs, and the Qₘ is a modulation order of one of the two TBs.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is the first parameter, and the Qₘ is a modulation order of one of the two TBs.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) in one of the two TBs, and the Qₘ is the first parameter.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M/is a number of resource element(s) comprised in a set of resource element(s) available for a UCI transmission in an OFDM symbol, the N_{L} is a number of transmission layer(s) of a TB corresponding to the first parameter in the two TBs, and the Qₘ is a modulation order of a TB corresponding to the first parameter in the two TBs.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is the first parameter, and the Qₘ is a modulation order of a TB corresponding to the first parameter in the two TBs.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) of a TB corresponding to the first parameter in the two TBs, and the Qₘ is the first parameter.

In one embodiment, when the target condition is satisfied: when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a total number of transmission layers of the two TBs, and the Qₘ is the first parameter.

In one embodiment, when the target condition is satisfied: the first parameter is used to determine the first reference number.

In one embodiment, when the target condition is satisfied: the first parameter is used to indicate the first reference number.

In one embodiment, when the target condition is satisfied: the first parameter explicitly indicates the first

reference number.

In one embodiment, when the target condition is satisfied: the first parameter implicitly indicates the first reference number.

In one embodiment, when the target condition is satisfied: the first parameter is used to configure the first reference number.

In one embodiment, when the target condition is satisfied: the first reference number is equal to a smallest one of multiple intermediate values, all the multiple intermediate values are non-negative integers, and one of the multiple intermediate values depends on the first parameter.

In one embodiment, when the target condition is satisfied: the first reference number is equal to a smallest one of multiple intermediate values, all the multiple intermediate values are non-negative integers, and the first parameter is used to determine at least one of the multiple intermediate values.

In one embodiment, when the target condition is satisfied: the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and one of the multiple intermediate values depends on the first parameter.

In one embodiment, when the target condition is satisfied: the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and the first parameter is used to determine at least one of the multiple intermediate values.

In one embodiment, a transmission layer of a TB is a transmission layer to which a codeword mapped by the TB is mapped.

In one embodiment, a modulation order of a TB is a modulation order adopted by a modulation symbol generated by a coded bit generated by the TB.

In one embodiment, a modulation order of a TB is a modulation order adopted by a modulation symbol generated by a codeword to which the TB is mapped.

In one embodiment, one of the multiple intermediate values is

$$⌈ \frac{( O 1 + L 1 ) \cdot β1 \cdot {Σ}_{l = 0}^{N} M ( l )}{{Σ}_{r = 0}^{{C}_{T B} - 1} {K}_{r}} ⌉ ,$$

and another one of the multiple intermediate values is ┌α·Σₗ₌ₖ_{₀}^{N}M(l)┐; where 01 is equal to 2, L1 is equal to 0; β1 is an offset value for a HARQ-ACK, the M(l) is a number of resource element(s) that can be used to transmit a UCI in OFDM symbol l, and the N is a total number of OFDM symbol(s) of the first PUSCH, the l₀ is an index of a first one of OFDM symbol(s) not bearing DMRS after the first DMRS (Demodulation Reference Signal) symbol(s) in a transmission of the first PUSCH; the α is configured by a higher-layer parameter scaling; the Kᵣ is a size of an r-th code block of a TB corresponding to the first parameter in the two TBs, and the C_{TB} is a number of code block(s) in a TB corresponding to the first parameter in the two TBs.

In one embodiment, a size of at least one code block in the TB corresponding to the first parameter in the two TBs depends on the first parameter.

In one embodiment, the first parameter is used to determine a size of at least one code block in the TB corresponding to the first parameter in the two TBs.

In one embodiment, the first parameter is used to indicate a size of at least one code block in the TB corresponding to the first parameter in the two TBs.

In one embodiment, the first parameter explicitly indicates a size of at least one code block in the TB corresponding to the first parameter in the two TBs.

In one embodiment, the first parameter implicitly indicates a size of at least one code block in the TB corresponding to the first parameter in the two TBs.

In one embodiment, the first parameter is used to configure a size of at least one code block in the TB corresponding to the first parameter in the two TBs.

In one embodiment, a size of the TB corresponding to the first parameter in the two TBs depends on the first parameter.

In one embodiment, the first parameter is used to determine a size of the TB corresponding to the first parameter in the two TBs.

In one embodiment, the first parameter is used to indicate a size of the TB corresponding to the first parameter in the two TBs.

In one embodiment, the first parameter explicitly indicates a size of the TB corresponding to the first parameter in the two TBs.

In one embodiment, the first parameter implicitly indicates a size of the TB corresponding to the first parameter in the two TBs.

In one embodiment, the first parameter is used to configure a size of the TB corresponding to the first parameter in the two TBs.

In one embodiment, a size of at least one code block in the TB corresponding to the first parameter is determined after a first input bit sequence is through at least a former of code block segmentation and code block CRC attachment, and a number of bit(s) comprised in the first input bit sequence depends on a size of the TB corresponding to the first parameter in the two TBs.

In one embodiment, a number of bit(s) comprised in the first input bit sequence is not less than a size of the TB corresponding to the first parameter in the two TBs.

In one embodiment, a number of bit(s) comprised in the first input bit sequence is: a number of bit(s) in the TB corresponding to the first parameter in the two TBs (comprising Cyclic Redundancy Check (CRC)).

In one embodiment, a number of bit(s) comprised in the first input bit sequence is: a sum of a number of bit(s) in the TB corresponding to the first parameter in the two TBs and a number of corresponding TB CRC check bit(s).

In one embodiment, the first input bit sequence is obtained by the TB corresponding to the first parameter in the two TBs through TB CRC attachment.

In one embodiment, a size of a TB or a code block refers to: a number of bit(s) comprised in the TB or the code block.

In one embodiment, a size of a TB refers to: a number of bit(s) comprised in the TB after being transferred to layer 1.

In one embodiment, when the target condition is met, only a former of the first parameter and the second parameter is used to determine the first reserved resource pool.

In one embodiment, when the target condition is met, the second parameter is used to determine the first reserved resource pool.

In one embodiment, when the target condition is met, the first parameter and the second parameter are used to determine the first reserved resource pool.

In one embodiment, when the target condition is met, the first parameter and the second parameter are used together to indicate the first reserved resource pool.

In one embodiment, when the target condition is satisfied: the first parameter and the second parameter are used to determine the first reference number.

In one embodiment, when the target condition is satisfied: the first parameter and the second parameter are used to indicate the first reference number.

In one embodiment, when the target condition is satisfied: the first parameter and the second parameter are used together to implicitly indicate the first reference number.

In one embodiment, when the target condition is satisfied: the first parameter and the second parameter are used to configure the first reference number.

In one embodiment, when the target condition is satisfied: the first reference number is equal to a smallest one of multiple intermediate values, all the multiple intermediate values are non-negative integers, and one of the multiple intermediate values depends on the first parameter and the second parameter.

In one embodiment, when the target condition is satisfied: the first reference number is equal to a smallest one of multiple intermediate values, all the multiple intermediate values are non-negative integers, and the first parameter and the second parameter are used to determine at least one of the multiple intermediate values.

In one embodiment, when the target condition is satisfied: the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and one of the multiple intermediate values depends on the first parameter and the second parameter.

In one embodiment, when the target condition is satisfied: the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and the first parameter and the second parameter are used to determine at least one of the multiple intermediate values.

In one embodiment, one of the multiple intermediate values is

$$⌈ \frac{( O 1 + L 1 ) \cdot β1 \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ ,$$

and another one of the multiple intermediate values is Πα·Σₗ₌ₗ_{₀}^{N}M(l)┐; where the O1 is equal to 2, and the L1 is equal to 0; the β1 is an offset value for HARQ-ACK, the M(l) is a number of resource element(s) that can be used to transmit UCI in OFDM symbol l, and the N is a total number of OFDM symbols of the first PUSCH, the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are respectively a size of an r1-th code block in the TB corresponding to the first parameter in the two TBs and a size of an r2-th code block in the TB corresponding to the second parameter in the two TBs, and the C_{TB1} and the C_{TB2} are respectively a number of code block(s) in the TB corresponding to the first parameter in the two TBs and a number of code block(s) in the TB corresponding to the second parameter in the two TBs.

In one embodiment, one of the multiple intermediate values is

$$⌈ \frac{2 ( O 1 + L 1 ) \cdot β1 \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ ,$$

and another one of the multiple intermediate values is ┌α·Σₗ₌ₗ_{₀}^{N}M(l)┐; where the O1 is equal to 2, and the L1 is equal to 0; β1 is an offset value for HARQ-ACK, the M(l) is a number of resource element(s) that can be used to transmit a UCI in OFDM symbol l, and the N is a total number of OFDM symbol(s) of the first PUSCH, the l₀ is an index of a first OFDM symbol not bearing DMRS after a first DMRS symbol(s) in a transmission of the first PUSCH; the α is configured by a higher-layer parameter scaling; the Kᵣ₁ and the Kᵣ₂ are respectively a size of an r1-th code block in the TB corresponding to the first parameter in the two TBs and a size of an r2-th code block in the TB corresponding to the second parameter in the two TBs, and the C_{TB1} and the C_{TB2} are respectively a number of code block(s) in the TB corresponding to the first parameter in the two TBs and a number of code block(s) in the TB corresponding to the second parameter in the two TBs.

In one embodiment, a code block in a TB refers to: a code block generated by the TB.

In one embodiment, a code block in a TB refers to: a code block obtained by taking bits in this TB (and a corresponding TB CRC) as input and through at least a former of code block segmentation and code block CRC attachment.

In one embodiment, a size of at least one code block in the TB corresponding to the second parameter in the two TBs depends on the second parameter.

In one embodiment, the second parameter is used to determine a size of at least one code block in the TB corresponding to the second parameter in the two TBs.

In one embodiment, the second parameter is used to indicate a size of at least one code block in the TB corresponding to the second parameter in the two TBs.

In one embodiment, the second parameter explicitly indicates a size of at least one code block in the TB corresponding to the second parameter in the two TBs.

In one embodiment, the second parameter implicitly indicates a size of at least one code block in the TB corresponding to the second parameter in the two TBs.

In one embodiment, the second parameter is used to configure a size of at least one code block in the TB corresponding to the second parameter in the two TBs.

In one embodiment, a size of the TB corresponding to the second parameter in the two TBs depends on the second parameter.

In one embodiment, the second parameter is used to determine a size of the TB corresponding to the second parameter in the two TBs.

In one embodiment, the second parameter is used to indicate a size of the TB corresponding to the second parameter in the two TBs.

In one embodiment, the second parameter explicitly indicates a size of the TB corresponding to the second parameter in the two TBs.

In one embodiment, the second parameter implicitly indicates a size of the TB corresponding to the second parameter in the two TBs.

In one embodiment, the second parameter is used to configure a size of the TB corresponding to the second parameter in the two TBs.

In one embodiment, a size of at least one code block in the TB corresponding to the second parameter is determined after a second input bit sequence is through at least a former of code block segmentation and code block CRC attachment, and a number of bit(s) comprised in the second input bit sequence depends on a size of the TB corresponding to the second parameter in the two TBs.

In one embodiment, a number of bit(s) comprised in the second input bit sequence is not less than a size of the TB corresponding to the second parameter in the two TBs.

In one embodiment, a number of bit(s) comprised in the second input bit sequence is: a number of bit(s) in the TB corresponding to the second parameter in the two TBs (comprising CRC).

In one embodiment, a number of bit(s) comprised in the second input bit sequence is: a sum of a number of bit(s) in the TB corresponding to the second parameter in the two TBs and a number of corresponding TB CRC check bit(s).

In one embodiment, the second input bit sequence is obtained by the TB corresponding to the second parameter in the two TBs through TB CRC attachment.

In one embodiment, when the target condition is satisfied: a first reference number is used to determine the first reserved resource pool, the first reference number is equal to a smallest one of multiple intermediate values, all the multiple intermediate values are non-negative integers, and one of the multiple intermediate values depends on the first parameter.

In one embodiment, when the target condition is satisfied: a first reference number is related to a number of reserved resource element(s) used for potential HARQ-ACK transmission, the first reference number, together with the first parameter, is used to determine the first interval, the first interval being a positive integer, and the first reserved resource pool depends on the first interval.

### Embodiment 7

Embodiment 7 illustrates a schematic diagram of a target coded bit group according to one embodiment of the present application, as shown in FIG. 7.

In embodiment 7, the target coded bit group comprises coded bits for only one of the two TBs.

In one embodiment, the target coded bit group comprises coded bit(s) of one of the two TBs, while the target coded bit group does not comprise coded bit(s) of a TB other than the one of the two TBs.

In one embodiment, the target coded bit group comprises coded bit(s) of a TB corresponding to the first parameter in the two TBs, and the target coded bit group does not comprise coded bit(s) of a TB corresponding to the second parameter in the two TBs.

In one embodiment, the target coded bit group comprises coded bit(s) of a TB corresponding to the second parameter in the two TBs, and the target coded bit group does not comprise coded bit(s) of a TB corresponding to the first parameter in the two TBs.

In one embodiment, the target coded bit group is a multiplexed data and control coded bit sequence.

In one embodiment, all bits in the target coded bit group are bits in a same codeword.

In one embodiment, all bits in the target coded bit group are bits in a codeword to which a TB is mapped corresponding to the first parameter in the two TBs.

In one embodiment, all bits in the target coded bit group are bits in a codeword to which a TB corresponding to the second parameter is mapped in the two TBs.

In one embodiment, the two TBs are respectively mapped to two codewords, and all bits in the target coded bit group are used for a codeword corresponding to a same TB in the two TBs.

In one embodiment, the two TBs are respectively mapped to two codewords, and all bits in the target coded bit group are comprised in a codeword corresponding to a same TB in the two TBs.

### Embodiment 8

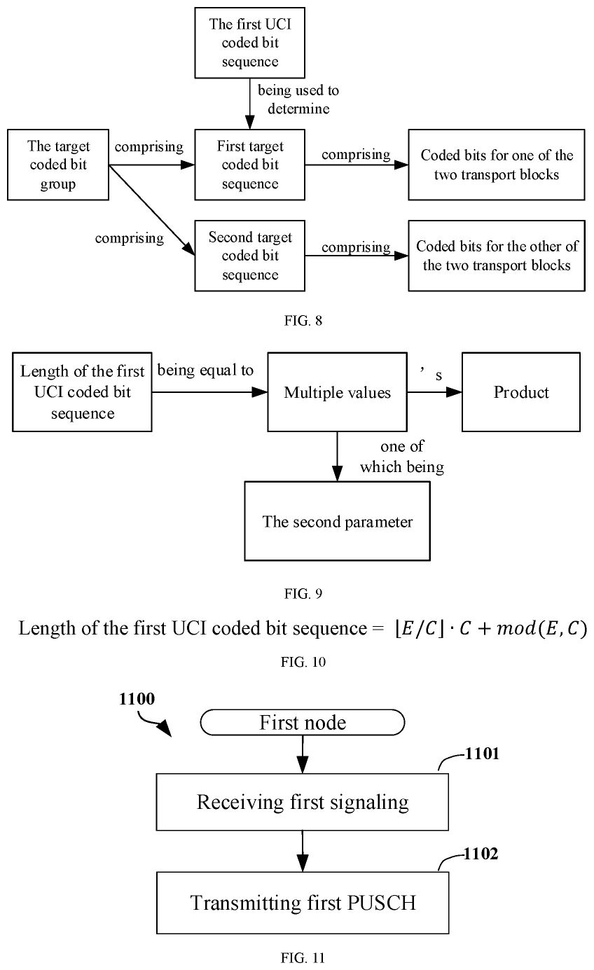

Embodiment 8 illustrates a schematic diagram of relations among a target coded bit group, a first target coded bit sequence, a second target coded bit sequence, two TBs and a first UCI coded bit sequence according to one embodiment of the present application, as shown in FIG. 8.

In embodiment 8, the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence,

In one embodiment, the target coded bit group comprises a first target coded bit sequence and a second target coded bit sequence, coded bits for the two TBs are respectively used to generate the first target coded bit sequence and the second target coded bit sequence, and the first UCI coded bit sequence is used to determine the first target coded bit sequence.

In one embodiment, the first UCI coded bit sequence is used to generate the first target coded bit sequence.

In one embodiment, the first UCI coded bit sequence is used to obtain the first target coded bit sequence.

In one embodiment, the first target coded bit sequence is a multiplexed data and control coded bit sequence, and the second target coded bit sequence is a multiplexed data and control coded bit sequence.

In one embodiment, the first target coded bit sequence is a multiplexed data and control coded bit sequence, and the second target coded bit sequence is a UL-SCH coded bit sequence.

In one embodiment, the first target coded bit sequence comprises coded bits of a TB corresponding to the first parameter in the two TBs, and the second target coded bit sequence comprises coded bits of a TB corresponding to the second parameter in the two TBs.

In one embodiment, the first target coded bit group does not comprise coded bits of a TB corresponding to the second parameter in the two TBs, and the second target coded bit sequence does not comprise coded bits of a TB corresponding to the first parameter in the two TBs.

In one embodiment, the second parameter value is for a TB corresponding to the first target coded bit sequence in the two TBs, and the first parameter value is for a TB corresponding to the second target coded bit sequence in the two TBs.

In one embodiment, the first parameter value is for a TB corresponding to the first target coded bit sequence in the two TBs, and the second parameter value is for a TB corresponding to the second target coded bit sequence in the two TBs.

In one embodiment, the first target coded bit sequence comprises the first UCI coded bit sequence.

In one embodiment, the two TBs are respectively mapped to two codewords; the target coded bit group comprises a first target coded bit sequence and a second target coded bit sequence, the first target coded bit sequence and the second target coded bit sequence are respectively used for the two codewords, and the first UCI coded bit sequence is used to generate the first target coded bit sequence.

In one embodiment, the two TBs are respectively mapped to two codewords; the target coded bit group comprises a first target coded bit sequence and a second target coded bit sequence, the first target coded bit sequence and the second target coded bit sequence are respectively comprised in the two codewords, and the first UCI coded bit sequence is used to generate the first target coded bit sequence.

In one embodiment, the two TBs are respectively mapped to two codewords; the target coded bit group comprises a first target coded bit sequence and a second target coded bit sequence, the first target coded bit sequence and the second target coded bit sequence are respectively used for the two codewords, and the first UCI coded bit sequence is used to obtain the first target coded bit sequence.

In one embodiment, the two TBs are respectively mapped to two codewords; the target coded bit group comprises a first target coded bit sequence and a second target coded bit sequence, the first target coded bit sequence and the second target coded bit sequence are respectively comprised in the two codewords, and the first UCI coded bit sequence is used to obtain the first target coded bit sequence.

### Embodiment 9

Embodiment 9 illustrates a schematic diagram of relations among a first UCI coded bit sequence, multiple values, and a second parameter according to one embodiment of the present application, as shown in FIG. 9.

In embodiment 9, the length of the first UCI coded bit sequence is equal to a product of multiple values, the multiple values are non-negative integers, and one of the multiple values is the second parameter.

In one embodiment, the length of the first UCI coded bit sequence refers to a number of coded bits comprised in the first UCI coded bit sequence.

In one embodiment, the multiple values are 2 values.

In one embodiment, the multiple values are 3 values.

In one embodiment, the multiple values are 4 values.

In one embodiment, the multiple values are 5 values.

In one embodiment, the multiple values are 6 values.

In one embodiment, the multiple values are 7 values.

In one embodiment, the multiple values are 8 values.

In one embodiment, one of the multiple values is a number of transmission layer(s) used to map one of the two TBs.

In one embodiment, one of the multiple values is used to map a number of transmission layer(s) occupied by a codeword mapped to one of the two TBs.

In one embodiment, one of the multiple values is a modulation order of one of the two TBs.

In one embodiment, one of the multiple values is a number of coded modulation symbols per layer for a UCI corresponding to the first UCI coded bit sequence.

In one embodiment, one of the multiple values is configurable.

In one embodiment, one of the multiple values depends on a number of HARQ-ACK bit(s) comprised in the target HARQ-ACK bit block.

In one embodiment, one of the multiple values is a modulation order of a TB corresponding to the second parameter in the two TBs.

In one embodiment, one of the multiple values is a number of transmission layer(s) of a TB corresponding to the second parameter in the two TBs.

In one embodiment, one of the multiple values is a number of transmission layer(s) occupied by a codeword

to which a TB corresponding to the second parameter is mapped in the two TBs.

In one embodiment, one of the multiple values depends on a size of at least one code block comprised in at least one of the two TBs.

In one embodiment, one of the multiple values depends on a size of at least one code block comprised in each of the two TBs.

In one embodiment, one of the multiple values depends on a scheduled bandwidth of the first PUSCH.

In one embodiment, one of the multiple values is Q′_{UCI}, the

$${Q}_{UCI}^{′} = min \{ ⌈ \frac{( O + L ) \cdot β \cdot {Σ}_{l = 0}^{N} M ( l )}{{Σ}_{r = 0}^{{C}_{T B} - 1} {K}_{r}} ⌉ , ⌈ α \cdot {Σ}_{l = {l}_{0}}^{N} M ( l ) ⌉ \} ;$$

herein, O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbol(s) of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs.

In one embodiment, one of the multiple values is Q′_{UCI}, the

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ , ⌈ α \cdot {Σ}_{l = {l}_{0}}^{N} M ( l ) ⌉ \} ;$$

herein, O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, one of the multiple values is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, one of the multiple values is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ , ⌈ α \cdot {Σ}_{l = {l}_{0}}^{N} M ( l ) ⌉ - {Q}_{ACK}^{′} \} ;$$

herein, O the is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are receptively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or is a number of reserved resource element(s) used for potential HARQ-ACK transmission on at least one OFDM symbol, or, is equal to 0.

In one embodiment, one of the multiple values is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{TB} - 1} {K}_{r}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs; the Q′_{ACK} is a number of coded modulation symbol(s) per layer transmitted by a HARQ-ACK on the first PUSCH, or, or is a number of reserved resource element(s) used for potential HARQ-ACK transmission on at least one OFDM symbol, or, is equal to 0.

In one embodiment, one of the multiple values is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the Nis a total number of OFDM symbols of the first PUSCH; the α is configured by a higher-layer parameter scaling; the Kᵣ₁ and the Kᵣ₂ are respectively a size of an r1-th code block in one of the two TBs and a size of an r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or is a number of reserved resource element(s) used for potential HARQ-ACK transmission on at least one OFDM symbol, or, is equal to 0.

In one embodiment, the product of the multiple values is: a product of a first value, a second value and the second parameter.

In one embodiment, the product of the multiple values is: a product of a first value and a second parameter.

In one embodiment, the product of the multiple values is: a product of a second value and the second parameter.

In one embodiment, the first value depends on a number of HARQ-ACK bit(s) comprised in the target HARQ-ACK bit block, and the second value is a modulation order of a TB corresponding to the second parameter in the two TBs.

In one embodiment, the first value depends on a number of HARQ-ACK bit(s) comprised in the target HARQ-ACK bit block, and the second value is a number of transmission layer(s) of a TB corresponding to the second parameter in the two TBs.

In one embodiment, the first value depends on a number of HARQ-ACK bit(s) comprised in the target HARQ-ACK bit block, and the second value is a number of transmission layer(s) occupied by a codeword to which a TB corresponding to the second parameter is mapped in the two TBs.

In one embodiment, the second value is a modulation order of a TB corresponding to the second parameter in the two TBs.

In one embodiment, the second value is a number of transmission layer(s) of a TB corresponding to the second parameter in the two TBs.

In one embodiment, the second value is a number of transmission layer(s) occupied by a codeword to which a TB corresponding to the second parameter is mapped in the two TBs.

In one embodiment, the first value depends on a number of HARQ-ACK bit(s) comprised in the target HARQ-ACK bit block.

In one embodiment, the first value depends on a size of at least one code block comprised in at least one of the two TBs.

In one embodiment, the first value depends on a size of at least one code block comprised in each of the two TBs.

In one embodiment, the first value depends on a scheduled bandwidth of the first PUSCH.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{T B} - 1} {K}_{r}} ⌉ , ⌈ α \cdot {Σ}_{l = {l}_{0}}^{N} M ( l ) ⌉ \} ;$$

herein, O the is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, the first value is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{T B 1} - 1} {K}_{r 1} + {Σ}_{r 2 = 0}^{{C}_{T B 2} - 1} {K}_{r 2}} ⌉ , ⌈ α \cdot {Σ}_{l = {l}_{0}}^{N} M ( l ) ⌉ \} ;$$

herein, O the is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are respectively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{TB} - 1} {K}_{r}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the first value is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are respectively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the first UCI coded bit sequence is coded bits for HARQ-ACK, and the UCI corresponding to the first UCI coded bit sequence is HARQ-ACK.

In one embodiment, the first UCI coded bit sequence is coded bits for CSI part 1, and the UCI corresponding to the first UCI coded bit sequence is CSI part 1.

In one embodiment, the first UCI coded bit sequence is coded bits for CSI part 2, and the UCI corresponding to the first UCI coded bit sequence is CSI part 2.

In one embodiment, the first UCI coded bit sequence is coded bits for a UCI other than HARQ-ACK, CSI part 1, and CSI part 2, and the UCI corresponding to the first UCI coded bit sequence is a UCI other than HARQ-ACK, CSI part 1, and CSI part 2.

In one embodiment, the length of the first UCI coded bit sequence is equal to a sum of multiple values, the multiple values are non-negative integers, and one of the multiple values is the second parameter.

In one embodiment, the length of the first UCI coded bit sequence is equal to a linear combination of multiple values, the multiple values are non-negative integers, and one of the multiple values is the second parameter,

In one embodiment, the multiple values are positive integers.

### Embodiment 10

Embodiment 10 illustrates a schematic diagram of a length of a first UCI coded bit sequence according to one embodiment of the present application, as shown in FIG. 10.

In embodiment 10, the length of the first UCI coded bit sequence=[E/C]·C+mod(E,C); herein, E is equal to a product of multiple values, the multiple values are non-negative integers, and one of the multiple values is the second parameter; C is a number of code block(s) used for a UCI corresponding to the first UCI coded bit sequence, In one embodiment, the length of the first UCI coded bit sequence refers to a number of coded bit(s) comprised in the first UCI coded bit sequence.

In one embodiment, the multiple values are 2 values.

In one embodiment, the multiple values are 3 values.

In one embodiment, the multiple values are 4 values.

In one embodiment, the multiple values are 5 values.

In one embodiment, the multiple values are 6 values.

In one embodiment, the multiple values are 7 values.

In one embodiment, the multiple values are 8 values.

In one embodiment, one of the multiple values is a number of transmission layer(s) used to map one of the two TBs.

In one embodiment, one of the multiple values is used to map a number of transmission layer(s) occupied by a codeword to which one of the two TBs is mapped.

In one embodiment, one of the multiple values is a modulation order of one of the two TBs.

In one embodiment, one of the multiple values is a number of coded modulation symbols per layer for a UCI corresponding to the first UCI coded bit sequence.

In one embodiment, one of the multiple values is configurable.

In one embodiment, one of the multiple values depends on a number of HARQ-ACK bit(s) comprised in the target HARQ-ACK bit block.

In one embodiment, one of the multiple values is a modulation order of a TB corresponding to the second parameter in the two TBs.

In one embodiment, one of the multiple values is a number of transmission layer(s) of a TB corresponding to the second parameter in the two TBs.

In one embodiment, one of the multiple values is a number of transmission layer(s) occupied by a codeword to which a TB corresponding to the second parameter is mapped in the two TBs.

In one embodiment, one of the multiple values depends on a size of at least one code block comprised in at least one of the two TBs.

In one embodiment, one of the multiple values depends on a size of at least one code block comprised in

each of the two TBs.

In one embodiment, one of the multiple values depends on a scheduled bandwidth of the first PUSCH.

In one embodiment, one of the multiple values is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{TB} - 1} {K}_{r}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs.

In one embodiment, one of the multiple values is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, one of the multiple values is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, one of the multiple values is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are receptively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, one of the multiple values is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{TB} - 1} {K}_{r}} ⌉ , ⌈ α \cdot {Σ}_{l = {l}_{0}}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, one of the multiple values is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are respectively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the product of the multiple values is: a product of a first value, a second value and the second parameter.

In one embodiment, the product of the multiple values is: a product of a first value and a second parameter.

In one embodiment, the product of the multiple values is: a product of a second value and a second parameter.

In one embodiment, the first value depends on a number of HARQ-ACK bit(s) comprised in the target HARQ-ACK bit block, and the second value is a modulation order of a TB corresponding to the second parameter in the two TBs.

In one embodiment, the first value depends on a number of HARQ-ACK bit(s) comprised in the target HARQ-ACK bit block, and the second value is a number of transmission layer(s) of a TB corresponding to the second parameter in the two TBs.

In one embodiment, the first value depends on a number of HARQ-ACK bit(s) comprised in the target HARQ-ACK bit block, and the second value is a number of transmission layer(s) occupied by a codeword to which a TB corresponding to the second parameter is mapped in the two TBs.

In one embodiment, the second value is a modulation order of a TB corresponding to the second parameter in the two TBs.

In one embodiment, the second value is a number of transmission layer(s) of a TB corresponding to the second parameter in the two TBs.

In one embodiment, the second value is a number of transmission layer(s) occupied by a codeword to which a TB corresponding to the second parameter is mapped in the two TBs.

In one embodiment, the first value depends on a number of HARQ-ACK bit(s) comprised in the target HARQ-ACK bit block.

In one embodiment, the first value depends on a size of at least one code block comprised in at least one of the two TBs.

In one embodiment, the first value depends on a size of at least one code block comprised in each of the two TBs.

In one embodiment, the first value depends on a scheduled bandwidth of the first PUSCH.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{TB} - 1} {K}_{r}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, the first value is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = {l}_{0}}^{N} M ( l ) ⌉ \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH, and the l₀ is an index of a first one of OFDM symbol(s) not bearing DMRS after first DMRS symbol(s) in a transmission of the first PUSCH; the α is configured by a higher-layer parameter scaling; the Kᵣ₁ and the Kᵣ₂ are receptively a size of an r1-th code block in one of the two TBs and a size of a r2-th code block in the other of the two TBs, and the C_{TB1} and the C_{TB2} are respectively a number of code block(s) in the two TBs.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are respectively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the first value is Q′_{UCI},

$${Q}_{UCI}^{′} = min \{ ⌈ \frac{( O + L ) \cdot β \cdot {Σ}_{l = 0}^{N} M ( l )}{{Σ}_{r = 0}^{{C}_{TB} - 1} {K}_{r}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ is a size of an r-th code block of a TB corresponding to the second parameter in the two TBs, and the C_{TB} is a number of code block(s) in a TB corresponding to the second parameter in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the first value is Q′_{UCI},

$${Q}_{UCI}^{′} = min \{ ⌈ \frac{2 ( O + L ) \cdot β \cdot {Σ}_{l = 0}^{N} M ( l )}{{Σ}_{r 1 = 0}^{{C}_{TB 1} - 1} {K}_{r 1} + {Σ}_{r 2 = 0}^{{C}_{TB 2} - 1} {K}_{r 2}} ⌉ , ⌈ α \cdot {Σ}_{l = 0}^{N} M ( l ) ⌉ - {Q}_{ACK}^{′} \} ;$$

herein, the O is a number of bit(s) for UCI corresponding to the first UCI coded bit sequence, the L is a number of CRC bit(s) (L can be equal to or greater than 0), the β is an offset value for the UCI corresponding to the first UCI coded bit sequence, the M(l) is a number of resource element(s) that can be used to transmit UCI in OFDM symbol l, the N is a total number of OFDM symbols of the first PUSCH; the α is configured by a higher-layer parameter scaling; the Kᵣ₁ and the Kᵣ₂ are respectively a size of the r1-th code block in one of the two TBs and a size of the r2-th code block in the other of the two TBs, the C_{TB1} and the C_{TB2} are respectively a number of code block(s) in the two TBs; the Q′_{ACK} is a number of coded modulation symbol(s) per layer transmitted by a HARQ-ACK on the first PUSCH, or a number of reserved resource element(s) used for potential HARQ-ACK transmission on at least one OFDM symbol, or, is equal to 0.

In one embodiment, the first UCI coded bit sequence is coded bits for HARQ-ACK, and the UCI corresponding to the first UCI coded bit sequence is HARQ-ACK.

In one embodiment, the first UCI coded bit sequence is coded bits for CSI part 1, and the UCI corresponding to the first UCI coded bit sequence is CSI part 1.

In one embodiment, the first UCI coded bit sequence is coded bits for CSI part 2, and the UCI corresponding to the first UCI coded bit sequence is CSI part 2.

In one embodiment, the first UCI coded bit sequence is coded bits for a UCI other than HARQ-ACK, CSI part 1, and CSI part 2, and the UCI corresponding to the first UCI coded bit sequence is a UCI other than HARQ-ACK, CSI part 1, and CSI part 2.

In one embodiment, the length of the first UCI coded bit sequence is equal to a sum of multiple values, the multiple values are non-negative integers, and one of the multiple values is the second parameter.

In one embodiment, the length of the first UCI coded bit sequence is equal to a linear combination of multiple values, the multiple values are non-negative integers, and one of the multiple values is the second parameter.

In one embodiment, the multiple values are positive integers.

### Embodiment 11

Embodiment 11 illustrates a processing flowchart of a first node according to one embodiment of the present application, as shown in FIG. 11.

In Embodiment 11, the first node in the present application receives a first signaling in step 1101; transmits a PUSCH in step 1102.

In embodiment 11, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the first PUSCH carries a target coded bit group, the target coded bit group comprises multiple coded bits; the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one embodiment, a number of HARQ-ACK bits transmitted on the first PUSCH is not greater than 2.

In one embodiment, a number of HARQ-ACK bits transmitted on the first PUSCH is not greater than 4.

In one embodiment, a number of HARQ-ACK bits transmitted on the first PUSCH is not greater than 1706.

In one embodiment, there does not exist HARQ-ACK information being multiplexed onto the first PUSCH.

In one embodiment, at least a part of the target coded bit group depends on the first UCI coded bit sequence.

In one embodiment, at least a part of the target coded bit group depends on the first reserved resource pool.

In one embodiment, the meaning of the expression of “the target coded bit group depending on a first reserved resource pool” is: a generation of the target coded bit group depends on a number of resource element(s) in the first reserved resource pool.

In one embodiment, the expression of “the target coded bit group depending on a first reserved resource pool” comprises: a generation of the target coded bit group depends on a number of resource element(s) in the first reserved resource pool.

In one embodiment, the meaning of the expression of “the target coded bit group depending on a first reserved resource pool” is: an acquisition of the target coded bit group depends on a number of resource element(s) in the first reserved resource pool.

In one embodiment, the expression of “the target coded bit group depending on a first reserved resource pool” comprises: an acquisition of the target coded bit group depends on a number of resource element(s) in the first reserved resource pool.

In one embodiment, only when the target condition is met, the first parameter is only used to determine the first reserved resource pool.

In one embodiment, only when the target condition is met, the first parameter is used to determine the first reserved resource pool, the target coded bit group depends on the first reserved resource pool.

In one embodiment, the target condition is related to a number of HARQ-ACK bit(s) comprised in the target HARQ-ACK bit block.

In one embodiment, the target condition comprises that a number of HARQ-ACK bit(s) comprised in the target HARQ-ACK bit block is not greater than a reference value, and the reference value is a constant or configurable positive integer.

In one embodiment, at least one of the target coded bit group or the first UCI coded bit sequence depends on the target HARQ-ACK bit block.

In one embodiment, the target HARQ-ACK bit block comprises at least one HARQ-ACK bit.

In one embodiment, the first PUSCH is not used to transmit a CG-UCI.

In one embodiment, the first reserved resource pool is used to indicate at least part of coded bits in the target coded bit group.

In one embodiment, the first reserved resource pool is used to indicate an order of coded bits in the target coded bit group.

In one embodiment, the target coded bit set is obtained based on a first process, and the first process comprises a third assignment operation and a fourth assignment operation; in the third assignment operation, a value of a coded bit in coded bits in the target HARQ-ACK bit block is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the target coded bit group.

In one embodiment, the target coded bit set is obtained based on a first process, and the first process comprises a third assignment operation and a fourth assignment operation; in the third assignment operation, a value of a coded bit in the first UCI coded bit sequence is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the target coded bit group.

In one embodiment, the target coded bit set is obtained based on a first process, and the first process comprises a fifth assignment operation and a sixth assignment operation; in the fifth assignment operation, a value of a coded bit in the first UCI coded bit sequence is assigned to an intermediate bit corresponding to the second target index, and the second target index is a subcarrier index of a resource element in a first intermediate resource element set, and the first reserved resource pool is used to determine the first intermediate resource element set; in the sixth assignment operation, a value of the intermediate bit corresponding to the second target index is assigned to a coded bit in the target coded bit group.

In one embodiment, a number of resource element(s) comprised in the first reserved resource pool is used to indicate the target coded bit group.

In one embodiment, a number of resource element(s) comprised in the first reserved resource pool is used to determine the first target index.

In one embodiment, a number of resource element(s) comprised in the first reserved resource pool is used to determine the second target index.

In one embodiment, a number of resource element(s) comprised in the first reserved resource pool is used to indicate the first target index.

In one embodiment, a number of resource element(s) comprised in the first reserved resource pool is used to indicate the second target index.

In one embodiment, a number of resource element(s) comprised in the first reserved resource pool is used to indicate a second interval, the second interval being a positive integer, the second target index is a subcarrier index of a J2-th resource element in the first intermediate resource element set, and the J2 is a non-negative integral multiple of the second interval.

In one embodiment, a number of resource element(s) comprised in the first reserved resource pool is used to indicate a third interval, the third interval being a positive integer, the first target index is a subcarrier index of a J1-th resource element in the first reserved resource pool, and the J1 is a non-negative integral multiple of the third interval.

In one embodiment, the first reserved resource pool is used to indicate an order of at least partial bits in the target coded bit group.

In one embodiment, the target coded bit group comprises a first target coded bit sequence and a second target coded bit sequence, the first target coded bit sequence and the second target coded bit sequence respectively comprise coded bits for the two TBs, and the second target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs, and the first target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs, the first target coded bit sequence depends on the first reserved resource pool, and the second target coded bit sequence depends on the first reserved resource pool.

In one embodiment, the first reserved resource pool is used to indicate at least part of coded bits in the first target coded bit sequence.

In one embodiment, the first reserved resource pool is used to indicate an order of coded bits in the first target coded bit sequence.

In one embodiment, the first target coded bit sequence is obtained based on a first process, and the first process comprises a third assignment operation and a fourth assignment operation; in the third assignment operation, a value of a coded bit in coded bits in the target HARQ-ACK bit block is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the first target coded bit sequence.

In one embodiment, the first target coded bit sequence is obtained based on a first process, and the first process comprises a third assignment operation and a fourth assignment operation; in the third assignment operation, a value of a coded bit in the first UCI coded bit sequence is assigned to an intermediate bit corresponding to a first target index, and the first target index is a subcarrier index of a resource element in the first reserved resource pool; in the fourth assignment operation, a value of the intermediate bit corresponding to the first target index is assigned to a coded bit in the first target coded bit sequence.

In one embodiment, the first target coded bit sequence is obtained based on a first process, and the first process comprises a fifth assignment operation and a sixth assignment operation; in the fifth assignment operation, a value of a coded bit in the first UCI coded bit sequence is assigned to an intermediate bit corresponding to the second target index, and the second target index is a subcarrier index of a resource element in a first intermediate resource element set, and the first reserved resource pool is used to determine the first intermediate resource element set; in the sixth assignment operation, a value of the intermediate bit corresponding to the second target index is assigned to a coded bit in the first target coded bit sequence.

In one embodiment, a number of resource element(s) comprised in the first reserved resource pool is used to indicate the first target coded bit sequence.

In one embodiment, a number of resource element(s) comprised in the first reserved resource pool is used to determine the first target index.

In one embodiment, a number of resource element(s) comprised in the first reserved resource pool is used

to determine the second target index.

In one embodiment, a number of resource element(s) comprised in the first reserved resource pool is used to indicate the first target index.

In one embodiment, a number of resource element(s) comprised in the first reserved resource pool is used to indicate the second target index.

In one embodiment, a number of resource element(s) comprised in the first reserved resource pool is used to indicate a second interval, the second interval being a positive integer, the second target index is a subcarrier index of a J2-th resource element in the first intermediate resource element set, and the J2 is a non-negative integral multiple of the second interval.

In one embodiment, a number of resource element(s) comprised in the first reserved resource pool is used to indicate a third interval, the third interval being a positive integer, the first target index is a subcarrier index of a J1-th resource element in the first reserved resource pool, and the J1 is a non-negative integral multiple of the third interval.

In one embodiment, the first reserved resource pool is used to indicate at least part of coded bits in the second target coded bit sequence.

In one embodiment, the first reserved resource pool is used to indicate an order of coded bits in the second target coded bit sequence.

In one embodiment, the second target coded bit sequence is obtained based on a second process, and the second process comprises a seventh assignment operation and an eighth assignment operation; in the seventh assignment operation, a value of a coded bit in coded bits for the target HARQ-ACK bit block is assigned to an intermediate bit corresponding to a third target index, and the third target index is a subcarrier index of a resource element in the first reserved resource pool; in the eighth assignment operation, a value of the intermediate bit corresponding to the third target index is assigned to a coded bit in the second target coded bit sequence.

In one embodiment, the second target coded bit sequence is obtained based on a second process, and the second process comprises a seventh assignment operation and an eighth assignment operation; in the seventh assignment operation, a value of a coded bit in the first UCI coded bit sequence is assigned to an intermediate bit corresponding to a third target index, and the third target index is a subcarrier index of a resource element in the first reserved resource pool; in the eighth assignment operation, a value of the intermediate bit corresponding to the third target index is assigned to a coded bit in the second target coded bit sequence.

In one embodiment, the second target coded bit sequence is obtained based on a second process, and the second process comprises a ninth assignment operation and a tenth assignment operation; in the ninth assignment operation, a value of a coded bit in the first UCI coded bit sequence is assigned to an intermediate bit corresponding to a fourth target index, the fourth target index is a subcarrier index of a resource element in a second intermediate resource element set, and the first reserved resource pool is used to determine the second intermediate resource element set; in the tenth assignment operation, a value of the intermediate bit corresponding to the fourth target index is assigned to a coded bit in the second target coded bit sequence.

In one embodiment, a number of resource element(s) comprised in the first reserved resource pool is used to indicate the second target coded bit sequence.

In one embodiment, a number of resource element(s) comprised in the first reserved resource pool is used to determine the third target index.

In one embodiment, a number of resource element(s) comprised in the first reserved resource pool is used to determine the fourth target index.

In one embodiment, a number of resource element(s) comprised in the first reserved resource pool is used to indicate the third target index.

In one embodiment, a number of resource element(s) comprised in the first reserved resource pool is used to indicate the fourth target index.

In one embodiment, a number of resource element(s) comprised in the first reserved resource pool is used to indicate a fourth interval, the fourth interval is a positive integer, the fourth target index is a subcarrier index of a J4-th resource element in the second intermediate resource element set, and J4 is a non-negative integral multiple of the fourth interval.

In one embodiment, a number of resource element(s) comprised in the first reserved resource pool is used to indicate a fifth interval, the fifth interval being a positive integer, the third target index is a subcarrier index of a J3-th resource element in the first reserved resource pool, and the J3 is a non-negative integral multiple of the fifth interval.

In one embodiment, the first parameter is used to indicate the first reserved resource pool.

In one embodiment, the first parameter is used to indicate a number of resource element(s) comprised in the first reserved resource pool.

In one embodiment, the first parameter explicitly indicates the first reserved resource pool.

In one embodiment, the first parameter implicitly indicates the first reserved resource pool.

In one embodiment, the first parameter is used to configure the first reserved resource pool.

In one embodiment, the first parameter is used to determine a first interval, the first interval is a positive integer, and the first reserved resource pool depends on the first interval.

In one embodiment, the first interval is used to indicate the first reserved resource pool comprises which resource elements in a first reserved resource pool; the first resource element set comprises a set of resource element(s) available for data transmission in at least one OFDM symbol.

In one embodiment, the first reserved resource pool comprises an J-th resource element in a first resource element set, where J is a non-negative integral multiple of the first interval; the first resource element set comprises a set of resource element(s) available for data transmission in at least one OFDM symbol.

In one embodiment, the first parameter is used to indicate the first interval.

In one embodiment, the first parameter explicitly indicates the first interval.

In one embodiment, the first parameter implicitly indicates the first interval.

In one embodiment, the first parameter is used to configure the first interval.

In one embodiment, the first parameter is used to determine a first reference number, the first reference number is used to determine a first interval, the first interval is a positive integer, and the first reserved resource pool depends on the first interval.

In one embodiment, a first reference number depends on a number of reserved resource element(s) used for potential HARQ-ACK transmission, the first reference number, together with the first parameter, is used to determine the first interval, the first interval being a positive integer, and the first reserved resource pool depends on the first interval.

In one embodiment, a first reference number is related to a number of reserved resource element(s) used for potential HARQ-ACK transmission, the first reference number, together with the first parameter, is used to determine the first interval, the first interval being a positive integer, and the first reserved resource pool depends on the first interval.

In one embodiment, a first reference number is used to determine the first interval.

In one embodiment, a first reference number and the first parameter are used to determine the first interval.

In one embodiment, the first reference number and the first parameter are used together to indicate the first interval.

In one embodiment, the first reference number and the first parameter are used together to obtain the first interval through executing judgment.

In one embodiment, the first reference number is used to determine the first interval.

In one embodiment, the first reference number is used to indicate the first interval.

In one embodiment, the first reference number is used to obtain the first interval through executing judgment.

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) in one of the two TBs, and the Qₘ is a modulation order of one of the two TBs.

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is the first parameter, and the Qₘ is a modulation order of one of the two TBs.

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) in one of the two TBs, and the Qₘ is the first parameter,

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) of a TB corresponding to the first parameter in the two TBs, and the Qₘ is a modulation order of a TB corresponding to the first parameter in the two TBs.

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}19 Qₘ, the M is a number of resource element(s) comprised in a set of resource element(s) available for a UCI transmission in an OFDM symbol, the N_{L} is the first parameter, and the Qₘ is a modulation order of a TB corresponding to the first parameter in the two TBs.

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a number of transmission layer(s) of a TB corresponding to the first parameter in the two TBs, and the Qₘ is the first parameter.

In one embodiment, when G−m≥M·N_{L}·Qₘ, the first interval is equal to 1; when G−m<M·N_{L}·Qₘ, the first interval is equal to └M·N_{L}·Qₘ/(G−m)┘; where G is the first reference number, the m is a non-negative integral multiple of N_{L}·Qₘ, the M is a number of resource element(s) comprised in a set of resource element(s) available for a UCI transmission in an OFDM symbol, the N_{L} is a total number of transmission layers of the two TBs, and the Qₘ is the first parameter.

In one embodiment, the first parameter is used to determine the first reference number.

In one embodiment, the first parameter is used to indicate the first reference number.

In one embodiment, the first parameter explicitly indicates the first reference number.

In one embodiment, the first parameter implicitly indicates the first reference number.

In one embodiment, the first parameter is used to configure the first reference number.

In one embodiment, the first reference number is equal to a smallest one of multiple intermediate values, all the multiple intermediate values are non-negative integers, and one of the multiple intermediate values depends on the first parameter.

In one embodiment, the first reference number is equal to a smallest one of multiple intermediate values, all the multiple intermediate values are non-negative integers, and the first parameter is used to determine at least one of the multiple intermediate values.

In one embodiment, the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and one of the multiple intermediate values depends on the first parameter.

In one embodiment, the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and the first parameter is used to determine at least one of the multiple intermediate values.

In one embodiment, only a former of the first parameter and the second parameter is used to determine the first reserved resource pool.

In one embodiment, the second parameter is also used to determine the first reserved resource pool.

In one embodiment, both the first parameter and the second parameter are used to determine the first reserved resource pool.

In one embodiment, both the first parameter and the second parameter are used together to indicate the first reserved resource pool.

In one embodiment, both the first parameter and the second parameter are used to determine the first reference number.

In one embodiment, both the first parameter and the second parameter are used to indicate the first reference number.

In one embodiment, both the first parameter and the second parameter are used together to implicitly indicate the first reference number.

In one embodiment, both the first parameter and the second parameter are used to configure the first reference number.

In one embodiment, the first reference number is equal to a smallest one of multiple intermediate values, all the multiple intermediate values are non-negative integers, and one of the multiple intermediate values depends on the first parameter and the second parameter.

In one embodiment, the first reference number is equal to a smallest one of multiple intermediate values, all the multiple intermediate values are non-negative integers, and the first parameter and the second parameter are used to determine at least one of the multiple intermediate values.

In one embodiment, the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and one of the multiple intermediate values depends on the first parameter and the second parameter.

In one embodiment, the first reference number is equal to a product of a smallest one of multiple intermediate values, a number of transmission layer(s) of the TB corresponding to the first parameter in the two TBs, and a modulation order of the TB corresponding to the first parameter in the two TBs; all the multiple intermediate values are non-negative integers, and the first parameter and the second parameter are used to determine at least one of the multiple intermediate values.

In one embodiment, a first reference number is used to determine the first reserved resource pool, the first reference number is equal to a smallest one of multiple intermediate values, all the multiple intermediate values are non-negative integers, and one of the multiple intermediate values depends on the first parameter.

In one embodiment, a first reference number is related to a number of reserved resource element(s) used for potential HARQ-ACK transmission, the first reference number, together with the first parameter, is used to determine the first interval, the first interval being a positive integer, and the first reserved resource pool depends on the first interval.

In one embodiment, the first reserved resource pool is a set of reserved resource elements for potential HARQ-ACK transmission.

In one embodiment, the first reserved resource pool is a set of reserved resource elements for potential HARQ-ACK transmission in at least one OFDM symbol.

In one embodiment, the first reserved resource pool is a set of reserved resource elements for potential HARQ-ACK transmission in at least one OFDM symbol.

In one embodiment, the first reserved resource pool is a set of reserved resource elements used for potential HARQ-ACK transmission in an OFDM symbol.

### Embodiment 12

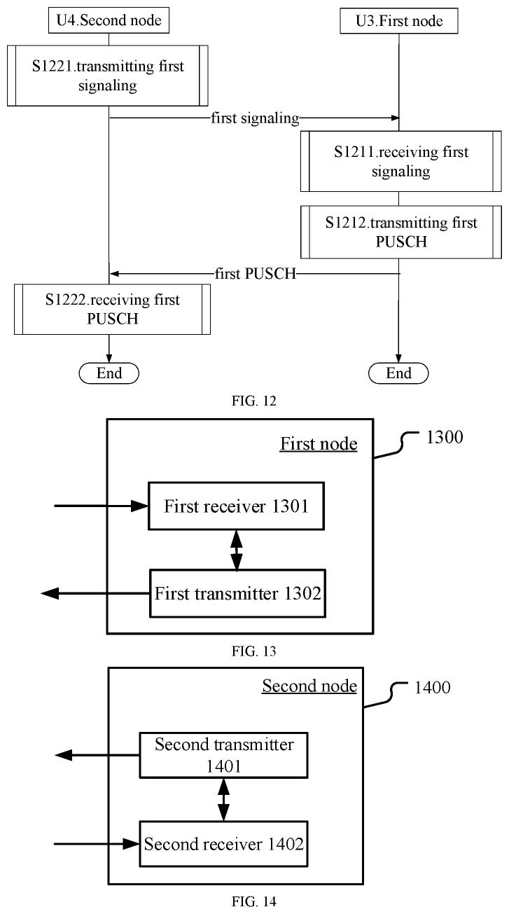

Embodiment 12 illustrates a flowchart of signal transmission according to one embodiment in the present application, as shown in FIG. 12. In FIG. 12, a first node U3 and a second node U4 are in communications via an air interface.

The first node U3 receives a first signaling in step S1211; transmits a first PUSCH in step S1212.

The second node U4 transmits a first signaling in step S1221; receives a first PUSCH in step S1222.

In embodiment 12, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the first PUSCH carries a target coded bit group, the target coded bit group comprises multiple coded bits; the first signaling is used to schedule the first PUSCH; the first UCI coded bit sequence comprises coded bits for UCI, and the length of the first UCI coded bit sequence is equal to a product of multiple values, all the multiple values are non-negative integers, one of the multiple values is the second parameter, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one subembodiment of embodiment 12, the first parameter is a modulation order of one of the two TBs, and the second parameter is a modulation order of the other of two TBs.

In one subembodiment of embodiment 12, the first parameter is a target code rate of one of the two TBs, and the second parameter is a target code rate of the other of the two TBs.

In one subembodiment of embodiment 12, the first parameter is a number of transmission layer(s) of one of the two TBs, and the second parameter is a number of transmission layer(s) of the other of the two TBs.

In one embodiment, the first node U3 is the first node in the present application.

In one embodiment, the second node U4 is the second node in the present application.

In one embodiment, the first node U3 is a UE.

In one embodiment, the first node U3 is a base station.

In one embodiment, the second node U4 is a base station.

In one embodiment, the second node U4 is a UE.

In one embodiment, an air interface between the second node U4 and the first node U3 is a Uu interface.

In one embodiment, an air interface between the second node U4 and the first node U3 comprises a cellular link.

In one embodiment, an air interface between the second node U4 and the first node U3 is a PC5 interface.

In one embodiment, an air interface between the second node U4 and the first node U3 comprises sidelink.

In one embodiment, an air interface between the second node U4 and the first node U3 comprises a radio interface between a base station and a UE.

In one embodiment, an air interface between the second node U4 and the first node U3 comprises a radio interface between a satellite and a UE.

In one embodiment, an air interface between the second node U4 and the first node U3 comprises a radio interface between a UE and a UE.

### Embodiment 13

Embodiment 13 illustrates a structure block diagram of a processor in a first node, as shown in FIG. 13. In FIG. 13, a processor 1300 of a first node comprises a first receiver 1301 and a first transmitter 1302.

In one embodiment, the first node 1300 is a base station.

In one embodiment, the first node 1300 is a UE.

In one embodiment, the first node 1300 is a relay node.

In one embodiment, the first node 1300 is a vehicle-mounted communication device.

In one embodiment, the first node 1300 is a UE that supports V2X communications.

In one embodiment, the first node 1300 is a relay node that supports V2X communications.

In one embodiment, the first node 1300 is a UE that supports operations on high-frequency spectrum.

In one embodiment, the first node 1300 is a UE that supports operations on shared frequency spectrum.

In one embodiment, the first node 1300 is a UE that supports XR services.

In one embodiment, the first node 1300 is a UE that supports multicast transmission.

In one embodiment, the first receiver 1301 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1301 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1302 comprises at least one of the antenna 452, the transmitter 454, the multi-antenna transmitting processor 457, the transmitting processor 468, the controller/processor 459, the memory 460, or the data source 467 in FIG. 4 of the present application.

In one embodiment, the first transmitter 1302 comprises at least first five of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises at least first four of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises at least first three of the antenna 452, the transmitter 454, the multi-antenna transmitting processor 457, the transmitting processor 468, the controller/processor 459, the memory 460, and the data source 467 in FIG. 4 of the present application.

In one embodiment, the first transmitter 1302 comprises at least first two of the antenna 452, the transmitter 454, the multi-antenna transmitting processor 457, the transmitting processor 468, the controller/processor 459, the memory 460, and the data source 467 in FIG. 4 of the present application.

In one embodiment, the first receiver 1301 receives a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the first transmitter 1302 transmits a first PUSCH, the first PUSCH carries a target coded bit group, the target coded bit group comprises multiple coded bits; herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one embodiment, when the target condition is not met, the first reserved resource pool is an empty set.

In one embodiment, the target coded bit group comprises coded bits for only one of the two TBs.

In one embodiment, all bits in the target coded bit group are bits in a same codeword.

In one embodiment, the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

In one embodiment, the first parameter is a modulation order of one of the two TBs, and the second parameter is a modulation order of the other of two TBs.

In one embodiment, the first parameter is a target code rate of one of the two TBs, and the second parameter is a target code rate of the other of the two TBs.

In one embodiment, the first parameter is a number of transmission layer(s) of one of the two TBs, and the second parameter is a number of transmission layer(s) of the other of the two TBs.

In one embodiment, the length of the first UCI coded bit sequence is equal to a product of multiple values, the multiple values are non-negative integers, and one of the multiple values is the second parameter.

In one embodiment, when the target condition is satisfied: the first parameter is used to determine a first interval, the first interval is a positive integer, and the first reserved resource pool depends on the first interval,

In one embodiment, when the target condition is met, the first reserved resource pool is a set of reserved resource elements for potential HARQ-ACK transmission in at least one OFDM symbol; the target condition comprises: a number of HARQ-ACK bit(s) comprised in the target HARQ-ACK bit block is not greater than 2,

In one embodiment, the target coded bit group comprises a first target coded bit sequence and a second target coded bit sequence, the first target coded bit sequence and the second target coded bit sequence respectively comprise coded bits for the two TBs; when the target condition is met, the second target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool, the second target coded bit sequence depends on the first reserved resource pool,

In one embodiment, the first receiver 1301 receives a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the first transmitter 1302 transmits a first PUSCH, the first PUSCH carries a target coded bit group, the target coded bit group comprises multiple coded bits; herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one embodiment, the target coded bit group comprises coded bits for only one of the two TBs.

In one embodiment, all bits in the target coded bit group are bits in a same codeword.

In one embodiment, the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

In one embodiment, the target coded bit group comprises a first target coded bit sequence and a second target coded bit sequence, the first target coded bit sequence and the second target coded bit sequence respectively comprise coded bits for the two TBs, and the second target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs, and the first target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs, the first target coded bit sequence depends on the first reserved resource pool, and the second target coded bit sequence depends on the first reserved resource pool.

In one embodiment, the first parameter is a modulation order of one of the two TBs, and the second parameter is a modulation order of the other of two TBs.

In one embodiment, the first parameter is a target code rate of one of the two TBs, and the second parameter is a target code rate of the other of the two TBs.

In one embodiment, the first parameter is a number of transmission layer(s) of one of the two TBs, and the second parameter is a number of transmission layer(s) of the other of the two TBs.

In one embodiment, the length of the first UCI coded bit sequence is equal to a product of multiple values, the multiple values are non-negative integers, and one of the multiple values is the second parameter,

In one embodiment, the first parameter is used to determine a first interval, the first interval is a positive integer, and the first reserved resource pool depends on the first interval.

In one embodiment, the first reserved resource pool is a set of reserved resource elements for potential HARQ-ACK transmission in at least one OFDM symbol.

In one embodiment, the target coded bit group comprises the first UCI coded bit sequence.

### Embodiment 14

Embodiment 14 illustrates a structure block diagram of a processor in a second node, as shown in FIG. 14, In FIG. 14, a processor 1400 of the second node comprises a second transmitter 1401 and a second receiver 1402.

In one embodiment, the second node 1400 is a UE.

In one embodiment, the second node 1400 is a base station.

In one embodiment, the second node 1400 is satellite.

In one embodiment, the second node 1400 is a relay node.

In one embodiment, the second node 1400 is a vehicle-mounted communication device.

In one embodiment, the second node 1400 is a UE that supports V2X communications.

In one embodiment, the second node 1400 is a device that supports operations on high-frequency spectrum.

In one embodiment, the second node 1400 is a device that supports operations on a shared spectrum.

In one embodiment, the second node 1400 is a device that supports XR services.

In one embodiment, the second node 1400 is one of testing devices, testing equipment, and testing instruments.

In one embodiment, the second transmitter 1401 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1401 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1402 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1402 comprises at least first five of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least first four of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least first three of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least first two of the antenna 420, the receiver 418, the multi-antenna receiving processor 472, the receiving processor 470, the controller/processor 475 and the memory 476 in FIG. 4 of the present application.

In one embodiment, the second transmitter 1401 transmits a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the second receiver 1402 receives a first PUSCH, the first PUSCH carries a target coded bit group, the target coded bit group comprises multiple coded bits; herein, the first signaling is used to schedule the first PUSCH; a first UCI coded bit sequence comprises coded bits for UCI, and a length of the first UCI coded bit sequence depends on the second parameter, the target coded bit group depends on the first UCI coded bit sequence, at least one of the target coded bit group or the first UCI coded bit sequence depends on the target HARQ-ACK bit block, and the target HARQ-ACK bit block comprises at least one HARQ-ACK bit; when a target condition is met, the target coded bit group depends on a first reserved resource pool, the first parameter is used to determine the first reserved resource pool, and the first reserved resource pool comprises reserved resource elements for potential HARQ-ACK transmission; only when the target condition is met, the first parameter is used to determine the first reserved resource pool; the target condition is a condition related to a number of HARQ-ACK bit(s) comprised in the target HARQ-ACK bit block.

In one embodiment, when the target condition is not met, the first reserved resource pool is an empty set.

In one embodiment, the target coded bit group comprises coded bits for only one of the two TBs.

In one embodiment, all bits in the target coded bit group are bits in a same codeword.

In one embodiment, the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

In one embodiment, the first parameter is a modulation order of one of the two TBs, and the second parameter is a modulation order of the other of two TBs.

In one embodiment, the first parameter is a target code rate of one of the two TBs, and the second parameter is a target code rate of the other of the two TBs.

In one embodiment, the first parameter is a number of transmission layer(s) of one of the two TBs, and the second parameter is a number of transmission layer(s) of the other of the two TBs.

In one embodiment, the length of the first UCI coded bit sequence is equal to a product of multiple values, the multiple values are non-negative integers, and one of the multiple values is the second parameter.

In one embodiment, when the target condition is satisfied: the first parameter is used to determine a first interval, the first interval is a positive integer, and the first reserved resource pool depends on the first interval.

In one embodiment, when the target condition is met, the first reserved resource pool is a set of reserved resource elements for potential HARQ-ACK transmission in at least one OFDM symbol; the target condition comprises: a number of HARQ-ACK bit(s) comprised in the target HARQ-ACK bit block is not greater than 2.

In one embodiment, the target coded bit group comprises a first target coded bit sequence and a second target coded bit sequence, the first target coded bit sequence and the second target coded bit sequence respectively comprise coded bits for the two TBs; when the target condition is met, the second target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs; when the target condition is met, the first target coded bit sequence depends on the first reserved resource pool, the second target coded bit sequence depends on the first reserved resource pool.

In one embodiment, the second transmitter 1401 transmits a first signaling, the first signaling is used to determine a first parameter and a second parameter, the first parameter and the second parameter are respectively for two TBs, the first parameter is one of MCS-related parameters or a number of transmission layer(s), and the second parameter is one of MCS-related parameters or a number of transmission layer(s); the second receiver 1402 receives a first PUSCH, the first PUSCH carries a target coded bit group, the target coded bit group comprises multiple coded bits; herein, the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

In one embodiment, the target coded bit group comprises coded bits for only one of the two TBs.

In one embodiment, all bits in the target coded bit group are bits in a same codeword.

In one embodiment, the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

In one embodiment, the target coded bit group comprises a first target coded bit sequence and a second target coded bit sequence, the first target coded bit sequence and the second target coded bit sequence respectively comprise coded bits for the two TBs, and the second target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs, and the first target coded bit sequence depends on the first reserved resource pool.

In one embodiment, the target coded bit group comprises a first target coded bit sequence and a second target coded bit sequence, the first target coded bit sequence and the second target coded bit sequence respectively comprise coded bits for the two TBs, the first target coded bit sequence depends on the first reserved resource pool, and the second target coded bit sequence depends on the first reserved resource pool.

In one embodiment, the first parameter is a modulation order of one of the two TBs, and the second parameter is a modulation order of the other of two TBs.

In one embodiment, the first parameter is a target code rate of one of the two TBs, and the second parameter is a target code rate of the other of the two TBs.

In one embodiment, the first parameter is a number of transmission layer(s) of one of the two TBs, and the second parameter is a number of transmission layer(s) of the other of the two TBs.

In one embodiment, the length of the first UCI coded bit sequence is equal to a product of multiple values, the multiple values are non-negative integers, and one of the multiple values is the second parameter.

In one embodiment, the first parameter is used to determine a first interval, the first interval is a positive integer, and the first reserved resource pool depends on the first interval.

In one embodiment, the first reserved resource pool is a set of reserved resource elements for potential HARQ-ACK transmission in at least one OFDM symbol.

In one embodiment, the target coded bit group comprises the first UCI coded bit sequence.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts and other wireless communication devices. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, diminutive airplanes, unmanned aerial vehicles, telecontrolled aircrafts, etc. The base station or network side equipment in the present application includes but is not limited to macro-cellular base stations, micro-cellular base stations, home base stations, relay base station, eNB, gNB. Transmitter Receiver Point (TRP), GNSS, relay satellites, satellite base stations, space base stations, test device, test equipment, test instrument and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to determine a first parameter and a second parameter, the first parameter and the second parameter being respectively for two Transport Blocks (TBs), the first parameter being one of MCS-related parameters or a number of transmission layer(s), and the second parameter being one of MCS-related parameters or a number of transmission layer(s); and a first transmitter, transmitting a first PUSCH, the first PUSCH carrying a target coded bit group, the target coded bit group comprising multiple coded bits;
wherein the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

2. The first node according to claim 1, wherein a target HARQ-ACK bit block comprises at least one HARQ-ACK bit, and at least one of the target coded bit group or the first UCI coded bit sequence depends on the target HARQ-ACK bit block.

3. The first node according to claim 1, wherein the target coded bit group comprises coded bits for only one of the two TBs;
or, wherein all bits in the target coded bit group are bits in a same codeword;
or, wherein the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

4. The first node according to claim 1, wherein the first parameter and the second parameter are respectively indicated by two different modulation and coding scheme (MCS) fields in the first signaling.

5. The first node according to claim 1, wherein the length of the first UCI coded bit sequence is equal to a product of multiple values, the multiple values are non-negative integers, and one of the multiple values is the second parameter.

6. The first node according to claim 4, wherein the first parameter is used to determine a first interval, the first interval is a positive integer, and the first reserved resource pool depends on the first interval.

7. The first node according to claim 4, wherein the first reserved resource pool is a set of reserved resource elements for potential HARQ-ACK transmission in at least one OFDM symbol; a number of HARQ-ACK bits transmitted on the first PUSCH is not greater than 2.

8. A second node for wireless communications, comprising:
a second transmitter, transmitting a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
a second receiver, receiving a first PUSCH, the first PUSCH carrying a target coded bit group, the target coded bit group comprising multiple coded bits;
wherein the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

9. The second node according to claim 8, wherein the target coded bit group comprises coded bits for only one of the two TBs;
or, wherein all bits in the target coded bit group are bits in a same codeword;
or, wherein the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

10. The second node according to claim 8, wherein the first parameter and the second parameter are respectively indicated by two different MCS fields in the first signaling.

11. The second node according to claim 8, wherein the length of the first UCI coded bit sequence is equal to a product of multiple values, the multiple values are non-negative integers, and one of the multiple values is the second parameter.

12. The second node according to claim 10, wherein the first parameter is used to determine a first interval, the first interval is a positive integer, and the first reserved resource pool depends on the first interval.

13. The second node according to claim 10, wherein the first reserved resource pool is a set of reserved resource elements for potential HARQ-ACK transmission in at least one OFDM symbol; a number of HARQ-ACK bits transmitted on the first PUSCH is not greater than 2.

14. A method in a first node for wireless communications, comprising:
receiving a first signaling, the first signaling being used to determine a first parameter and a second parameter, the first parameter and the second parameter being respectively for two TBs, the first parameter being one of MCS-related parameters or a number of transmission layer(s), and the second parameter being one of MCS-related parameters or a number of transmission layer(s); and
transmitting a first PUSCH, the first PUSCH carrying a target coded bit group, the target coded bit group comprising multiple coded bits;
wherein the first signaling is used to schedule the first PUSCH; a first UCI coded bit sequence comprises coded bits for UCI, a length of the first UCI coded bit sequence depends on the second parameter, and the target coded bit group depends on the first UCI coded bit sequence; the target coded bit group depends on a first reserved resource pool, the first reserved resource pool comprises reserved resource elements for potential HARQ-ACK transmission, and the first parameter is used to determine the first reserved resource pool.

15. The method in a first node according to claim 14, wherein a target HARQ-ACK bit block comprises at least one HARQ-ACK bit, and at least one of the target coded bit group or the first UCI coded bit sequence depends on the target HARQ-ACK bit block.

16. The method in a first node according to claim 14, wherein the target coded bit group comprises coded bits for only one of the two TBs;
or, wherein all bits in the target coded bit group are bits in a same codeword;
or, wherein the target coded bit group comprises a first target coded bit sequence and a second target coded bit sequence, the first target coded bit sequence and the second target coded bit sequence respectively comprise coded bits for the two TBs, and the first UCI coded bit sequence is used to determine the first target coded bit sequence.

17. The method in a first node according to claim 14, wherein the first parameter and the second parameter are respectively indicated by two different MCS fields in the first signaling.

18. The method in a first node according to claim 14, wherein the length of the first UCI coded bit sequence is equal to a product of multiple values, the multiple values are non-negative integers, and one of the multiple values is the second parameter.

19. The method in a first node according to claim 17, wherein the first parameter is used to determine a first interval, the first interval is a positive integer, and the first reserved resource pool depends on the first interval.

20. The method in a first node according to claim 17, wherein the first reserved resource pool is a set of reserved resource elements for potential HARQ-ACK transmission in at least one OFDM symbol; a number of HARQ-ACK bits transmitted on the first PUSCH is not greater than 2.
